(19) United States
(12) Patent Application Publication
(10) Pub. No.: US 2013/0255563 A1
(43) Pub. Date: Oct. 3, 2013

(54) Multi-Faceted Roadside Motor Vehicle Emergency Marker

(71) Applicant: Lee Lawrence Goodwyn, JR., Alexandria, VA (US)

(72) Inventor: Lee Lawrence Goodwyn, JR., Alexandria, VA (US)

(21) Appl. No.: 13/438,606

(22) Filed: Apr. 3, 2012

(51) Int. Cl. G01D 21/00

(52) U.S. Cl. 116/209

(57) ABSTRACT

The present invention is a multi-faceted roadside motor vehicle emergency marker. The marker includes a reversible marker body, a grommet with teeth, a body rod and attachment member with two terminal obstruction members, a message sleeve, a writing utensil attachment member, a motor vehicle attachment member, and a self source illuminator. The marker body is reversible and allows the user to select a visibility level depending upon their situation. The marker can be positioned on a motor vehicle component to alert passerby as well as provide passerby alerting illumination that does not require use of electricity. Each side includes a fastener to hold a writing utensil so the user can readily write down information pertinent to the motor vehicle condition or the emergency situation, in addition each side also has sleeve and a reservoir to contain, display, and protect information pertinent to the motor vehicle condition or the emergency situation.

### FIELD OF THE INVENTION

The present invention relates to the field of roadside markers . . . and more specifically to the field of roadside motor vehicle emergency markers that are reversible and allow a selection between various visibility levels. Also a roadside motor vehicle emergency marker that also provides a component that produces illumination that does not require the use of electricity. The present invention also relates to roadside motor vehicle emergency markers that can contain, display, and protect information relating to a motor vehicle condition or the emergency situation. Also this invention relates to a roadside motor vehicle emergency marker that can hold a writing utensil so that a user can readily write down information relating to the motor vehicle condition or the emergency situation. Additionally this invention pertains to roadside motor vehicle emergency markers that are not limited to attaching to a motor vehicle window or being used on the ground.

### BACKGROUND

Each year many motor vehicles break down or fail on the road or on the side of the road each year. When a motor vehicle breaks down a person usually has to leave it to get help. In this case people usually place a rag in the window to indicate to others that their motor vehicle is in a broken down or failed state. A rag is also left to indicate to people who pass by to know that there is an emergency or potential emergency regarding the vehicle that it is on. For a number of very significant reasons people leave information at the scene of the motor vehicle emergency. When a person leaves their motor vehicle they often leave a sticky note (such as a “post it” note) or a piece of paper with writing on it attached to the motor vehicle. One reason is because they want to leave information behind in case someone stops by to offer help. Another reason is because they wish to leave information behind for a towing truck that is coming to get the motor vehicle. People can also leave information behind while they leave their vehicle so they can provide emergency information for the authorities in case they visit and inspect the scene while they are gone. This can provide assurance to the person who motor vehicle has failed because they feel that the chances of their motor vehicle being towed or carried away in their absence are significantly reduced. These are just some among many reasons why someone chooses to leave information behind at he scene of a motor vehicle breakdown.

There are many disadvantages to placing a sticky note, post it note, or paper message on the motor vehicle. At the time of motor vehicle breakdown some people do not have a paper or a writing utensil on hand at all. For those who do there are a number of things that can happen to the message they leave. The message can easily fall or fly off the car. The weather can put it through elements (such as rain) which can cause the message to fade or become unreadable. Plus the common rag that is carried around the motor vehicle (if any) doesn't provide the best surface or material for writing a message on and also displaying the message to others. Having no information at the scene of the motor vehicle emergency could have serious consequences.

Some people travel and have no rag or rag type item in their vehicle at all so they are not able to give any type of signal or indicator of their situation. There is a chance were just leaving a rag in the window may be not be seen too well. The chances of people who pass by not seeing it lower as nighttime approaches. If the rag happens to be a darker color the chances of it being seen decrease even more. The darker the rag the less visible it is at night and the chances of people seeing that the motor vehicle is in an emergency state is reduced.

Additionally sometimes the motor vehicle may be in a state where it will not allow the window to operate enough to put and secure a rag to it. This could be because the user has a motor vehicle window that is broken, misaligned, or stuck. There could also be a scenario were the motor vehicle power shuts down and doesn't allow the user to roll the window down at all. Sometimes people can't place anything on their window because they have a window that is broken and have plastic covered over it secured by tape.

Sometimes truckers who are carrying wide loads use a red or bright plastic flag on the side or back of their load. But this only serves to caution passerby that the load is wide. Some truckers who carry wood logs put a red or bright plastic flag on the end of the log but this is also only to caution passerby of the load. Some people who are carrying work supplies, tools, etc in the bag of their truck and place a flag or a rag on the back to make drivers and passerby aware that what they are carrying is sticking out beyond the vehicle in which they are carrying the items in. These plastic flag, and rags employed are not reflective. They also do not have space to hold a writing surface and/or a writing utensil. These rags or flags used do not provide illumination at nighttime unless a piece of reflective material is on them and light shines on it.

There are products that attempt to address the problem of providing a vehicle or motor vehicle emergency marker. While they provide the user something to indicate an emergency marker to other they have disadvantages. Current vehicle emergency markers do not have an information display function or feature that allows the user to leave information on the scene for then they leave the motor vehicle. Current vehicle emergency markers are also limited to either being mounted onto the side window of a vehicle or on the ground. This can become a significant disadvantage in if a user's window is in a state like mentioned previously.

Today people who have a motor vehicle emergency or encounter motor vehicle problem still have to place information somewhere on the scene separately of the marker. Also a user can be at a disadvantage with current products that attempt to address the solution because they are limited to using the product via the side window or the ground. As mentioned previously there can be a scenario where the window of limited or no function at all. Plus placing the marker on the ground can leave the marker prone to be knocked over, blown away, stolen, etc.

There are no roadside markers for automobile emergency or distress situations that allow the user to choose varying levels of reflectivity or visibility. In automobile emergency, distress, or breakdown situations normally people will opt for a marker or device that allows the highest reflectivity possible and the highest visibility possible. But there are some cases where someone wants to mark their automobile but not draw too much attention to their automobile. There are some cases where a person may want to mark their motor vehicle to be on the safe side but not draw a lot of attention from passerby. In this case they wish to opr for a marker to mark their automobile but one of lower visibility than reflective materials or high visibility colors.

There are also no roadside motor vehicle markers with multiple attachment devices that allows for the multiple choices for attaching itself to a motor vehicle. Additionally there are no roadside motor vehicle markers that posses a self lighting device or illuminator such as a “light stick” or “glow stick” along with a message sleeve and writing utensil holder. Some people use light sticks or glow sticks in some roadside emergencies but they do not give any detailed information. The glow stick or light sticks do are not able to contain, store, and protect information. Neither are they able to store a writing utensil. Plus after their light expires then there remains no signal at all. In case of a automobile breakdown, emergency, or distress some users may want to also use an illuminator such as a “light stick” or “glow stick” that will give off light for passerby to spot the car and marker. Having a marker that also has an illuminator (as offered with this invention) allows the user to have a two way advantage. If passerby light shines on the marker then the car will be noticed (and the benefits of this could then result). Then if passerby light does not happen to shine on the marker then the illuminator will give off its own light and will be an additional way to catch passerby attention. This will be substantially helpful if the roadside motor vehicle emergency is taken place further away from the road. If the passerby light does not reach that far enough to reflect on the reflective surface of the marker the illuminator will give off light and catch the passerby attention. The illumination can increase the chances to catch the attention of passerby attention that is near the car but going in a direction or area than where the car is located. There is no roadside emergency marker that has a combination of a self source illuminator and a reflective device. What is meant by self source illuminator is an illuminator that does not require a battery or electricity to illuminate.

In the event of a roadside emergency an important concern of the person affected is to conserve the existing battery power of their motor vehicle. Because of this the user may sparingly use their emergency flash function of their automobile. In this case having a marker with an illuminator will provide a light source that does not use the motor vehicle's battery power. In the case that the battery has no power an illuminator is a great source to still provide signaling light. There is no combination roadside marker device that can be attached to a motor vehicle in case of its roadside breakdown that provides a reflective marker and an illuminator

Therefore, there is a need for an apparatus that:
provides a marker for roadside motor vehicle emergencies that can contain, display, and protect information the user needs to leave regarding the situation.
provides a marker for roadside motor vehicle emergencies that is not limited to use with an motor vehicle window.
provides a marker for roadside motor vehicle emergencies that is not limited to use on the ground.
provides a marker for roadside motor vehicle emergencies that can hold a writing utensil so that a user can write down information relating to the motor vehicle condition or the emergency situation.
provides a marker for roadside motor vehicle emergencies that has a place where a user can contain, store and protect information pertinent to the motor vehicle condition or the emergency situation.
provides a marker that gives the user a choice of varying levels of visibility and can allow the user to switch back and forth between the levels as they choose.
provides a marker that allows a choice between multiple motor vehicle attachment members.
provides a marker for the attachment to a motor vehicle in a roadside emergency that can provides a combination of a reflective marker and self source illuminator.

### SUMMARY

The present invention is a multi-faceted roadside motor vehicle emergency marker. The multi-faceted roadside motor vehicle emergency marker comprises of a reversible marker body, a message sleeve, a motor vehicle attachment member, a writing utensil attachment member, a body rod and attachment member, an illuminator, and a grommet with teeth. The marker is reversible and allows a selection between various visibility levels. The marker also provides a component that produces illumination that is not generated by and does not require use of electricity. The present invention also can contain, display, and protect information relating to a motor vehicle's condition. The marker also can hold a writing utensil so that a user can readily write down information relating to the motor vehicle's condition. Additionally this invention provides a roadside motor vehicle emergency marker that is not limited to attaching to a motor vehicle window or being used on the ground.

Therefore, it is an aspect of the present invention to provide a marker for roadside motor vehicle emergencies that can contain, display, and protect information the user needs to leave regarding the situation.

It is a further aspect of the present invention to provide a marker for roadside motor vehicle emergencies that is not limited to use with a motor vehicle window.

It is still a further aspect of the present invention to provide a marker for roadside motor vehicle emergencies that is not limited to use on the ground.

It is still a further aspect of the present invention to provide a marker for roadside motor vehicle emergencies that can hold a writing utensil so that a user can write down information relating to the motor vehicle condition or the emergency situation.

It is still a further aspect of the present invention to provide a marker for roadside motor vehicle emergencies that has a place where a user can contain, store and protect information pertinent to the motor vehicle condition or the emergency situation.

It is still a further aspect of the present invention to provide a marker that gives the user a choice of varying levels of visibility and can allow the user to switch back and forth between the levels as they choose.

It is still a further aspect of the present invention to provide a marker that allows a choice between multiple vehicle attachment members.

It is still a further aspect of the present invention to provide a marker for the attachment to a motor vehicle in a roadside emergency that can provides a combination of a reflective marker and illuminator.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 shows a perspective, front view of the Multi-Faceted Roadside Motor Vehicle Emergency Marker 100.

FIG. 1A shows what is depicted in FIG. 1 but after the Multi-Faceted Roadside Motor Vehicle Emergency Marker 100 is reversed.

FIG. 1B shows a perspective, side view of the Multi-Faceted Roadside Motor Vehicle Emergency Marker 100 in use on a motor vehicle window.

FIG. 1C shows the same as FIG. 1B but the Multi-Faceted Roadside Motor Vehicle Emergency Marker 100 is on its reversed side.

FIG. 1D shows a perspective, side view of the Multi-Faceted Roadside Motor Vehicle Emergency Marker 100 in use with a motor vehicle antenna.

FIG. 1E shows the same as FIG. 1D but the Multi-Faceted Roadside Motor Vehicle Emergency Marker 100 is on its reversed side.

FIG. 1F shows a perspective, front view of the Multi-Faceted Roadside Motor Vehicle Emergency Marker 100 in use between a motor vehicle door.

FIG. 1G shows a sectional, side view of a portion of what is depicted in FIG. 1F.

FIG. 1H shows a perspective, diagonal view of a portion of the Multi-Faceted Roadside Motor Vehicle Emergency Marker 100.

FIG. 1I shows a sectional, side view of a portion of the Multi-Faceted Roadside Motor Vehicle Emergency Marker 100.

FIG. 1J shows a perspective, diagonal view of a portion of the Multi-Faceted Roadside Motor Vehicle Emergency Marker 100.

FIG. 1K shows a perspective, diagonal view of a portion of the Multi-Faceted Roadside Motor Vehicle Emergency Marker 100.

FIG. 1L shows a sectional, side view of a portion of the Multi-Faceted Roadside Motor Vehicle Emergency Marker 100.

FIG. 1M shows a perspective, side view of a portion of the Multi-Faceted Roadside Motor Vehicle Emergency Marker 100.

FIG. 1N shows a perspective, top view of a portion of the Multi-Faceted Roadside Motor Vehicle Emergency Marker 100.

FIG. 1O shows a sectional, side view of a portion of the Multi-Faceted Roadside Motor Vehicle Emergency Marker 100.

FIG. 1P shows a perspective, diagonal view of a portion of the Multi-Faceted Roadside Motor Vehicle Emergency Marker 100.

FIG. 1Q shows a perspective, top view of a portion of the Multi-Faceted Motor Vehicle Emergency Marker 100.

FIG. 1R shows a perspective, side view of a portion of the Multi-Faceted Motor Vehicle Emergency Marker 100.

FIG. 1S shows a perspective, diagonal view of a portion of the Multi-Faceted Motor Vehicle Emergency Marker 100.

FIG. 1T shows a perspective, diagonal view of a portion of the Multi-Faceted Motor Vehicle Emergency Marker 100.

FIG. 1U shows a sectional, side view of a portion of the Multi-Faceted Motor Vehicle Emergency Marker 100.

FIG. 1V shows a perspective, diagonal view of a portion of the Multi-Faceted Motor Vehicle Emergency Marker 100.

FIG. 1W shows a sectional, side view of a portion of the Multi-Faceted Motor Vehicle Emergency Marker 100.

FIG. 1X shows a perspective, diagonal view of a portion of the Multi-Faceted Motor Vehicle Emergency Marker 100.

FIG. 1Y shows a sectional, side view of a portion of the Multi-Faceted Motor Vehicle Emergency Marker 100.

FIG. 1Z shows a perspective, side view of a portion of the Multi-Faceted Motor Vehicle Emergency Marker 100.

FIG. 2 shows a sectional, side view of a portion of the Multi-Faceted Motor Vehicle Emergency Marker 100.

FIG. 2A shows a perspective, diagonal view of a portion of the Multi-Faceted Motor Vehicle Emergency Marker 100.

FIG. 2B shows a perspective, diagonal view of a portion of the Multi-Faceted Motor Vehicle Emergency Marker 100.

FIG. 2C shows a sectional, side view of a portion of the Multi-Faceted Motor Vehicle Emergency Marker 100.

FIG. 2D shows a perspective, diagonal view of a portion of the Multi-Faceted Motor Vehicle Emergency Marker 100.

FIG. 2E shows a sectional, side view of a portion of the Multi-Faceted Motor Vehicle Emergency Marker 100.

FIG. 2F shows a perspective, side view of a portion of the Multi-Faceted Motor Vehicle Emergency Marker 100.

FIG. 2G shows a sectional, side view of a portion of the Multi-Faceted Motor Vehicle Emergency Marker 100.

FIG. 2H shows a sectional, side view of a portion of the Multi-Faceted Motor Vehicle Emergency Marker 100.

FIG. 2I shows a perspective, diagonal view of a portion of the Multi-Faceted Motor Vehicle Emergency Marker 100.

FIG. 2J shows a perspective, front view of a portion of the Multi-Faceted Motor Vehicle Emergency Marker 100.

FIG. 2K shows a perspective, side view of a portion of the Multi-Faceted Motor Vehicle Emergency Marker 100.

FIG. 2L shows a perspective, front view of a portion of the Multi-Faceted Motor Vehicle Emergency Marker 100.

FIG. 2M shows a perspective, diagonal view of a portion of the Multi-Faceted Motor Vehicle Emergency Marker 100.

FIG. 2N shows a perspective, diagonal view of a portion of the Multi-Faceted Motor Vehicle Emergency Marker 100.

FIG. 2O shows a perspective, top view of a portion of the Multi-Faceted Motor Vehicle Emergency Marker 100.

FIG. 2P shows a perspective, side view of a portion of the Multi-Faceted Motor Vehicle Emergency Marker 100.

FIG. 2Q shows a perspective, top view of a portion of the Multi-Faceted Motor Vehicle Emergency Marker 100.

FIG. 2R shows a perspective, top view of a portion of the Multi-Faceted Motor Vehicle Emergency Marker 100.

FIG. 2S shows a perspective, top view of a portion of the Multi-Faceted Motor Vehicle Emergency Marker 100.

FIG. 2T shows a perspective, top view of a portion of the Multi-Faceted Motor Vehicle Emergency Marker 100.

FIG. 2U shows a perspective, side view of a portion of the Multi-Faceted Motor Vehicle Emergency Marker 100.

FIG. 2V shows a perspective, side view of a portion of the Multi-Faceted Motor Vehicle Emergency Marker 100.

FIG. 3 shows a perspective, front view of a portion of another version of the Multi-Faceted Motor Vehicle Emergency Marker 100.

FIG. 3A shows a sectional, side view of a portion of another version of the Multi-Faceted Motor Vehicle Emergency Marker 100.

FIG. 3B shows a perspective, side view of a portion of another version of the Multi-Faceted Motor Vehicle Emergency Marker 100.

FIG. 3C shows a sectional, top view of a portion of another version of the Multi-Faceted Motor Vehicle Emergency Marker 100.

FIG. 3D shows a perspective, top diagonal view of a portion of another version of the Multi-Faceted Motor Vehicle Emergency Marker 100.

FIG. 3E shows a perspective, diagonal view of a portion of another version of the Multi-Faceted Motor Vehicle Emergency Marker 100.

FIG. 3F shows a perspective, front view of a portion of another version of the Multi-Faceted Motor Vehicle Emergency Marker 100.

FIG. 3G shows a perspective, front view of a portion of another version of the Multi-Faceted Motor Vehicle Emergency Marker 100.

FIG. 4 shows a perspective, top view of a portion of another version of the Multi-Faceted Motor Vehicle Emergency Marker 100.

FIG. 4A shows a perspective, top view of a portion of another version of the Multi-Faceted Motor Vehicle Emergency Marker 100.

FIG. 5 shows a perspective, side view of a portion of another version of the Multi-Faceted Motor Vehicle Emergency Marker 100.

FIG. 5A shows a sectional, side view of a portion of another version of the Multi-Faceted Motor Vehicle Emergency Marker 100.

FIG. 5B shows a perspective, front view of another version of the Multi-Faceted Motor Vehicle Emergency Marker 100.

FIG. 5C shows a perspective, front view of another version of the Multi-Faceted Motor Vehicle Emergency Marker 100.

FIG. 6 shows a sectional, side view of a portion of another version of the Multi-Faceted Motor Vehicle Emergency Marker 100.

FIG. 6A shows a perspective, front view of another version of the Multi-Faceted Motor Vehicle Emergency Marker 100.

FIG. 7 shows a perspective, diagonal view of a portion of another version of the Multi-Faceted Motor Vehicle Emergency Marker 100.

FIG. 7A shows a sectional, side view of a portion of another version of the Multi-Faceted Motor Vehicle Emergency Marker 100.

FIG. 7B shows a perspective, side view of a portion of another version of the Multi-Faceted Motor Vehicle Emergency Marker 100.

FIG. 7C shows a perspective, diagonal view of a portion of another version of the Multi-Faceted Motor Vehicle Emergency Marker 100.

FIG. 7D shows a sectional, side view of a portion of another version of the Multi-Faceted Motor Vehicle Emergency Marker 100.

FIG. 7E shows a perspective, side view of a portion of another version of the Multi-Faceted Motor Vehicle Emergency Marker 100.

FIG. 7F shows a perspective, side view of a portion of another version of the Multi-Faceted Motor Vehicle Emergency Marker 100.

FIG. 8 shows a perspective, side view of a portion of another version of the Multi-Faceted Motor Vehicle Emergency Marker 100.

FIG. 8A shows a perspective, diagonal side view of a portion of another version of the Multi-Faceted Motor Vehicle Emergency Marker 100.

FIG. 9 shows a perspective, diagonal view of a portion of another version of the Multi-Faceted Motor Vehicle Emergency Marker 100.

FIG. 10 shows a perspective, side view of a portion of another version of the Multi-Faceted Motor Vehicle Emergency Marker 100.

FIG. 10A shows a sectional, side view of a portion of another version of the Multi-Faceted Motor Vehicle Emergency Marker 100.

FIG. 10B Shows a perspective, size diagonal view of a portion of another version of the Multi-Faceted Motor Vehicle Emergency Marker 100.

FIG. 10C shows a perspective, side view of a portion of another version of the Multi-Faceted Motor Vehicle Emergency Marker 100.

### DETAILED DESCRIPTION

DEFINTIONS

Selfseal—Any device that can seal without the help of any third party
component (“Component” meaning any device that is not a human or a
living being)
Sleeve—Something that contains and can also cover or protect
Bag—A container or receptacle capable of being closed at the mouth
Illuminator—A device that illuminates
Self Source Illuminator—A device that illuminates without the use of
electricity or a device that illuminates by a self contained power
source such as a battery
Rod—an elongated piece of material or a piece of material having
notably more length than width
Terminal—Something at or near the end; OR something that ends a
process or event
Obstruction—Something that obstructs, blocks, or closes up
Stem—A slender or elongated structure connected to something
Socket—A hollow part or piece for receiving and holding some part or
thing
Flaccid—Lacking firmness, resilience, or vigor
Planar—Flat or level; OR of, or relating to, or situated in a plane
Pliable—Something can be easily bent, shaped, or moved
Passerby—A person, people, or traffic who happen to being going past
of near something
High Visibility Color—A color that has an increased degree or
capability of being noticed or seen

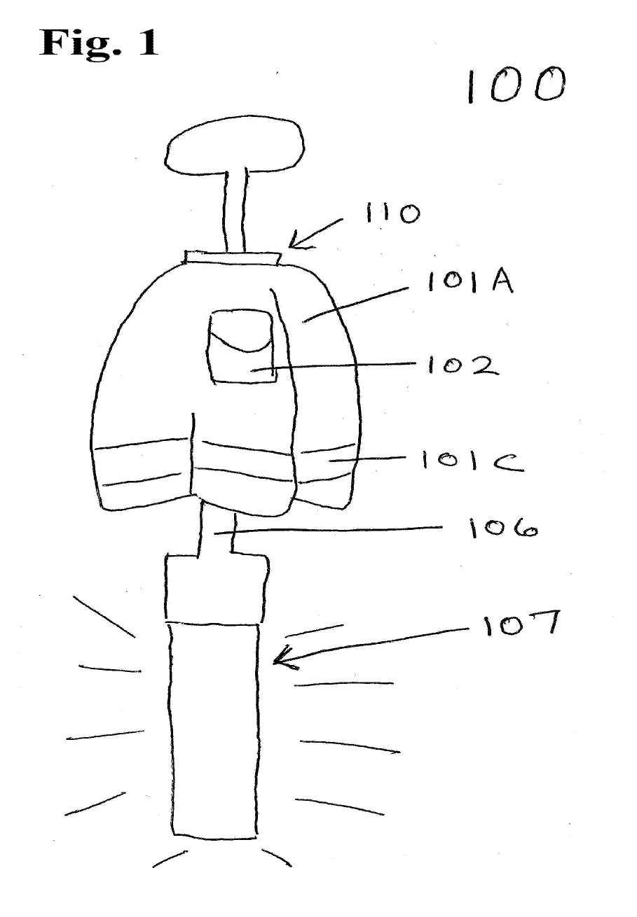

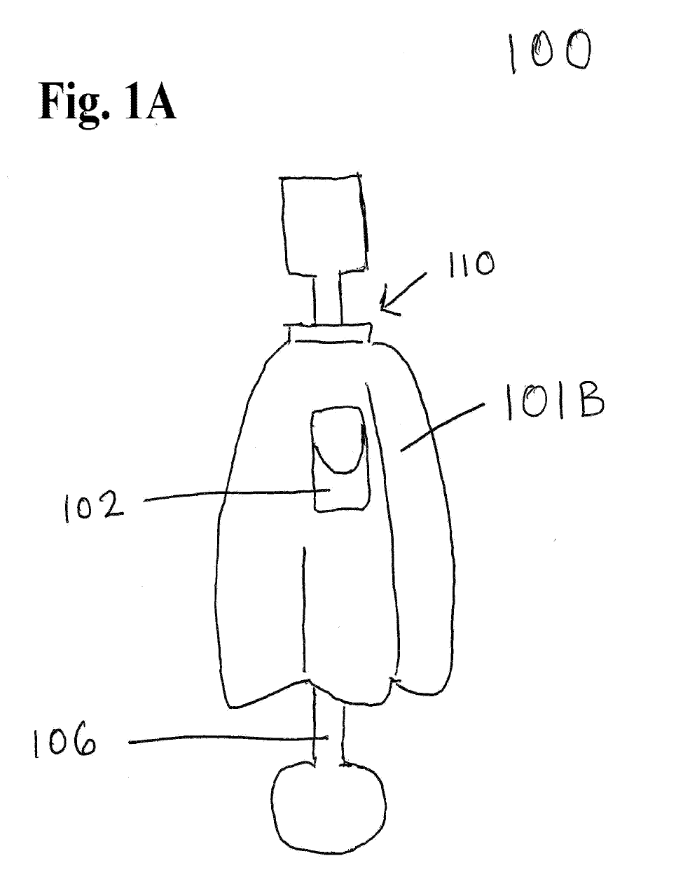

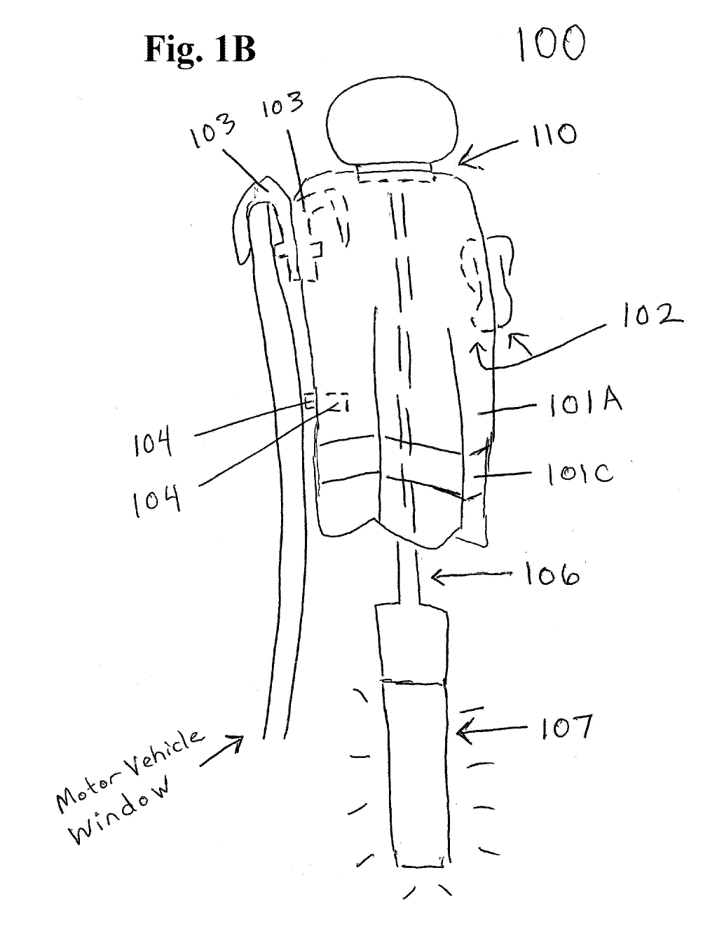

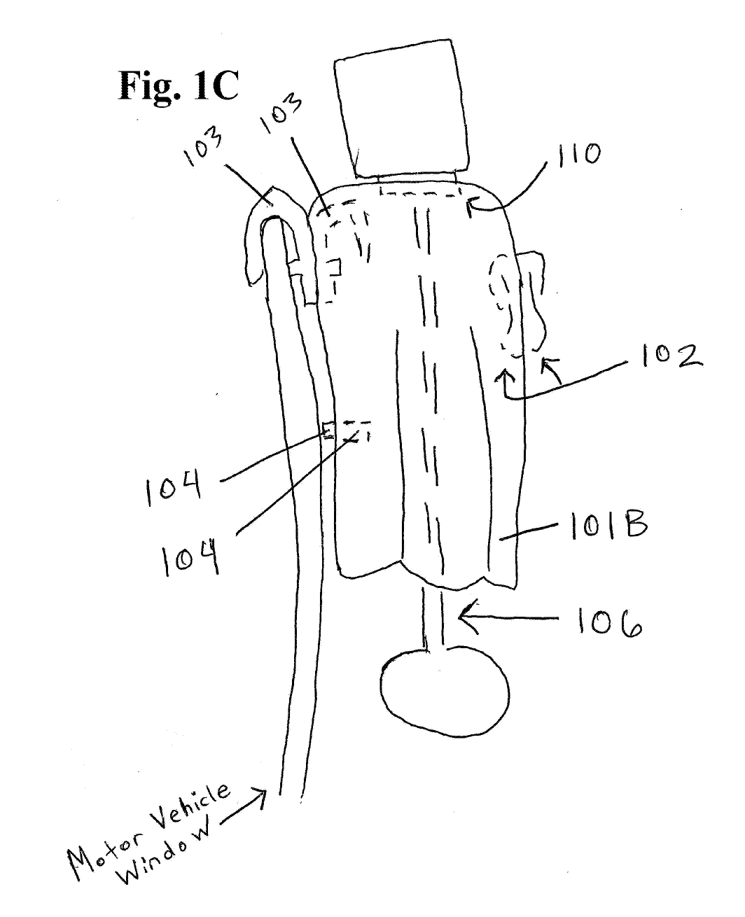

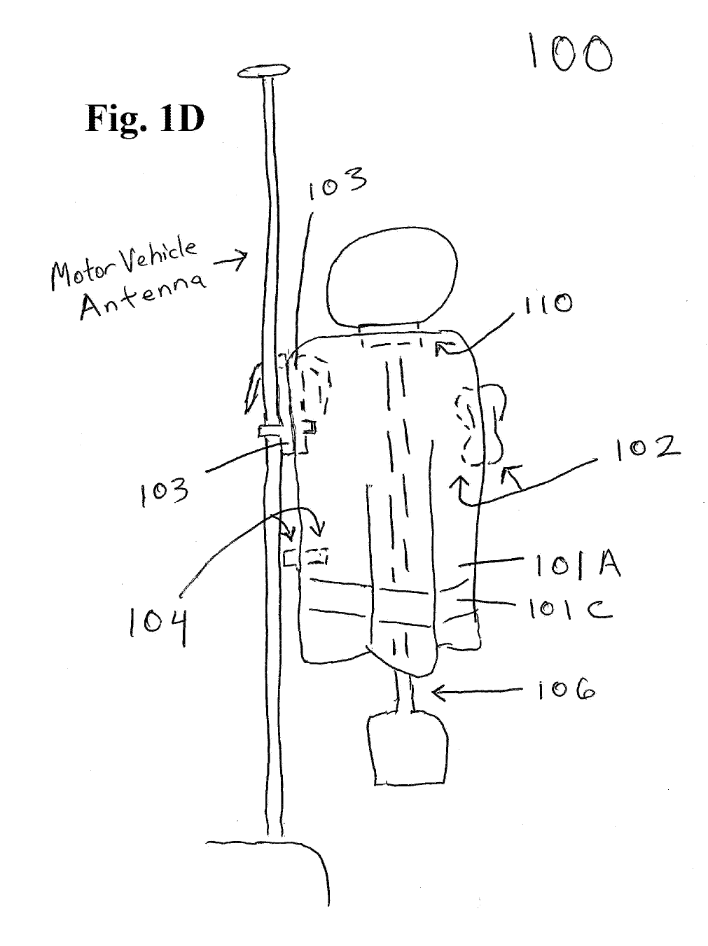

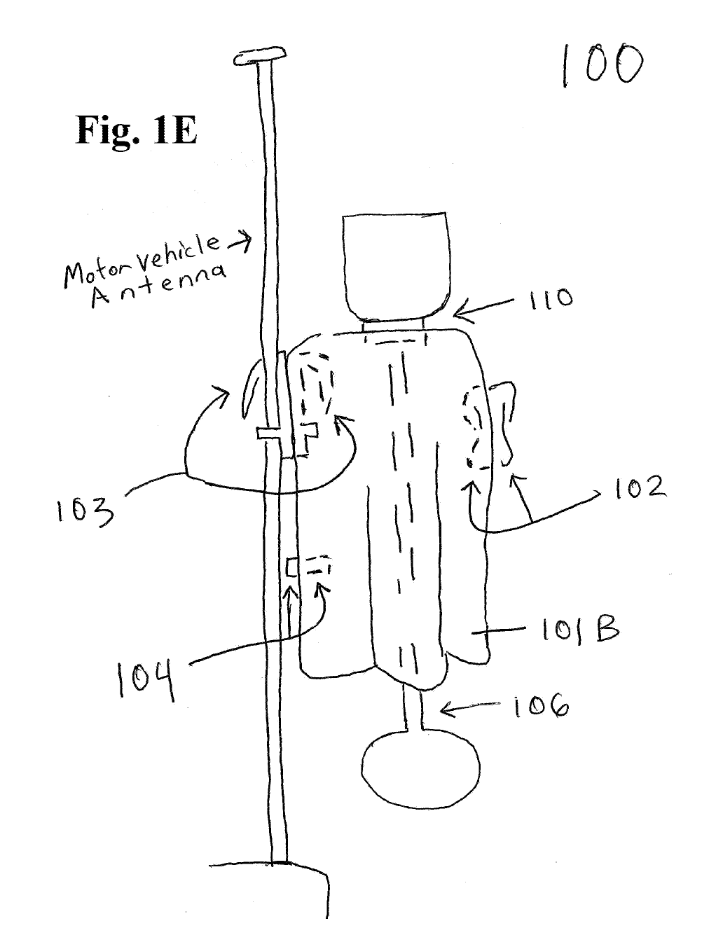

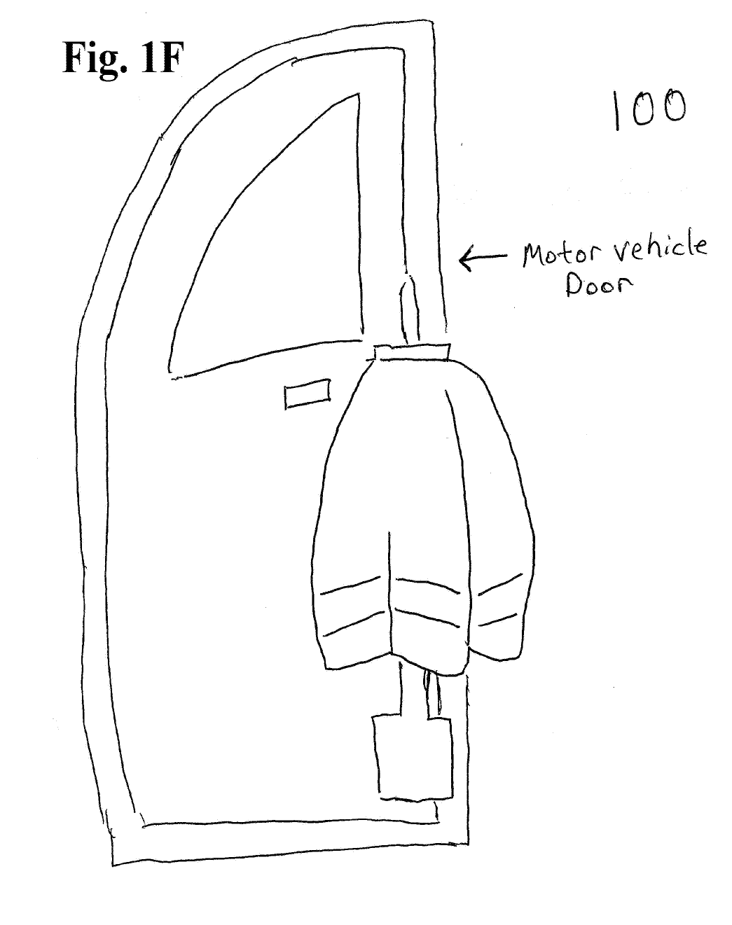

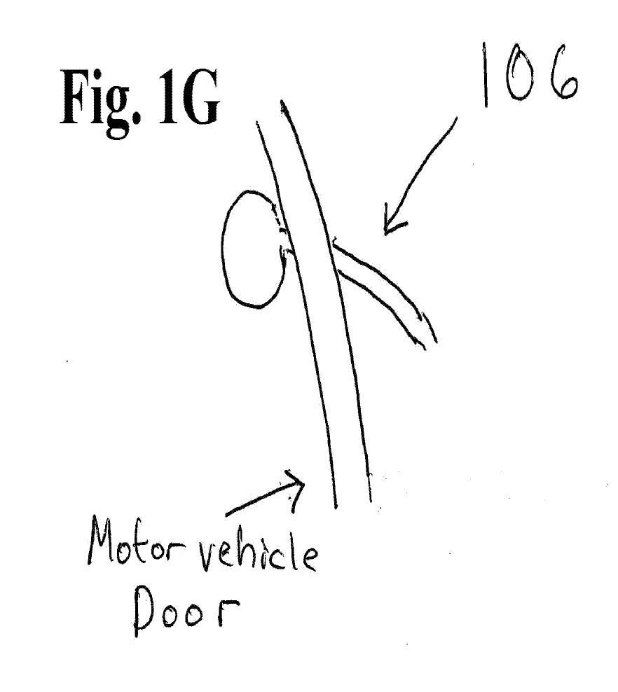

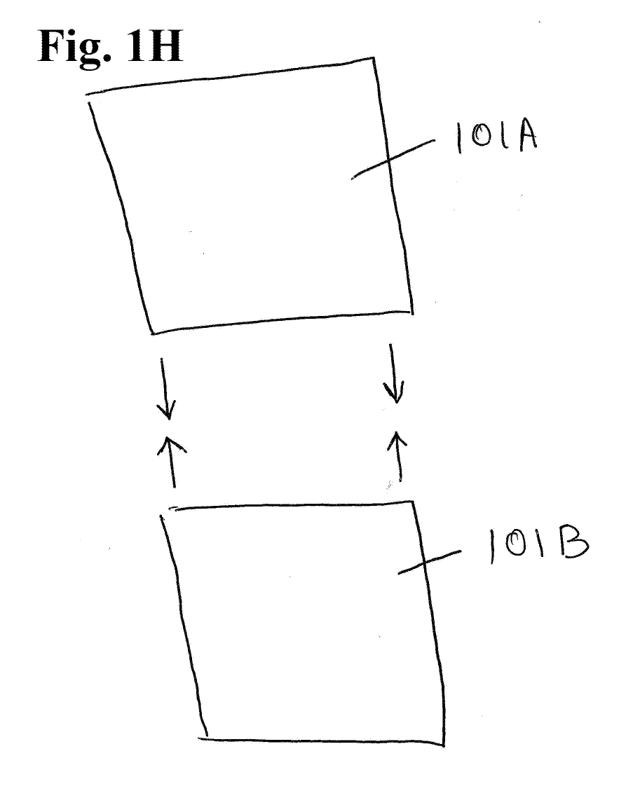

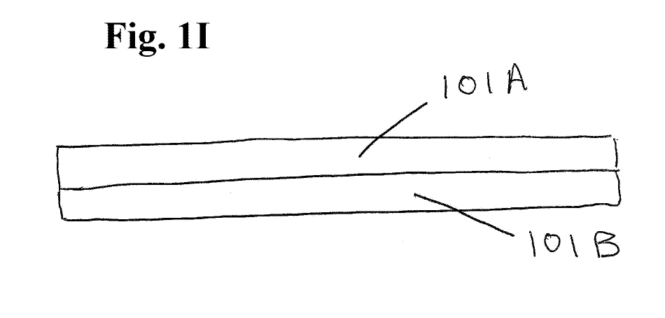

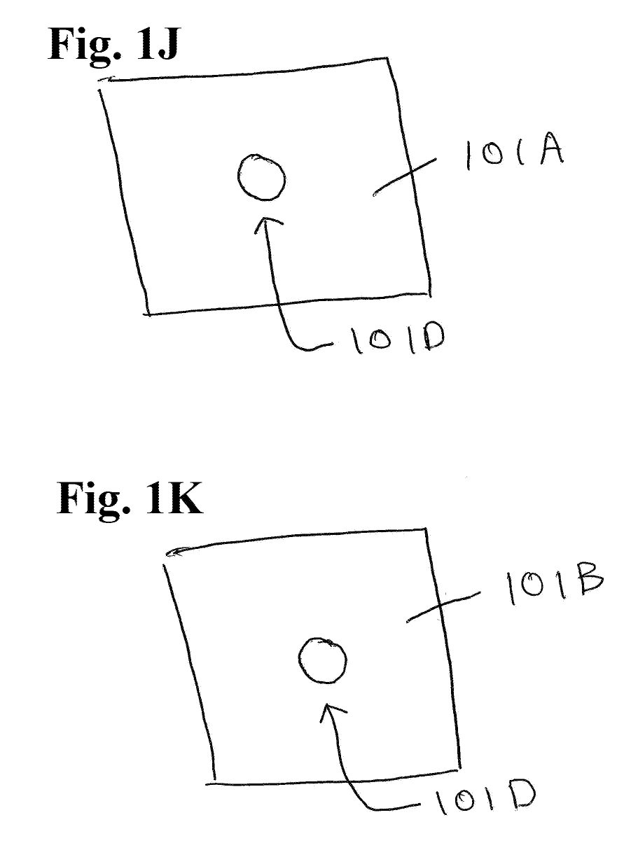

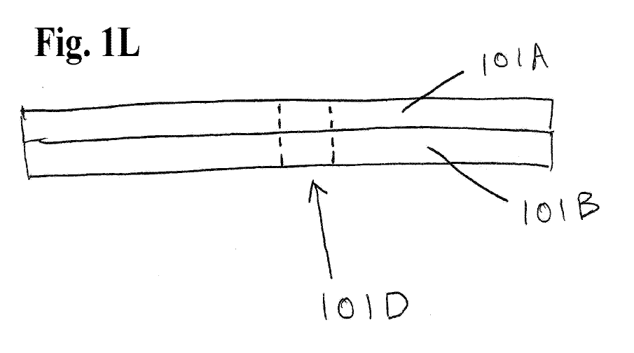

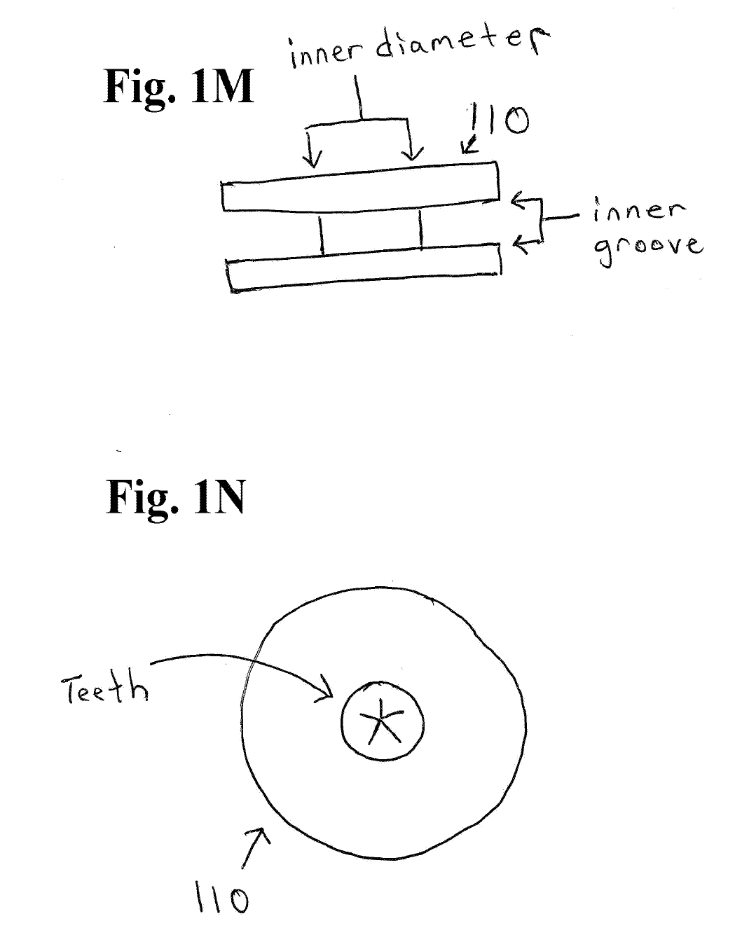

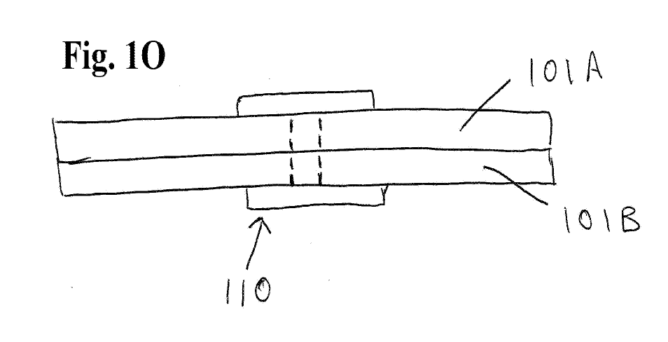

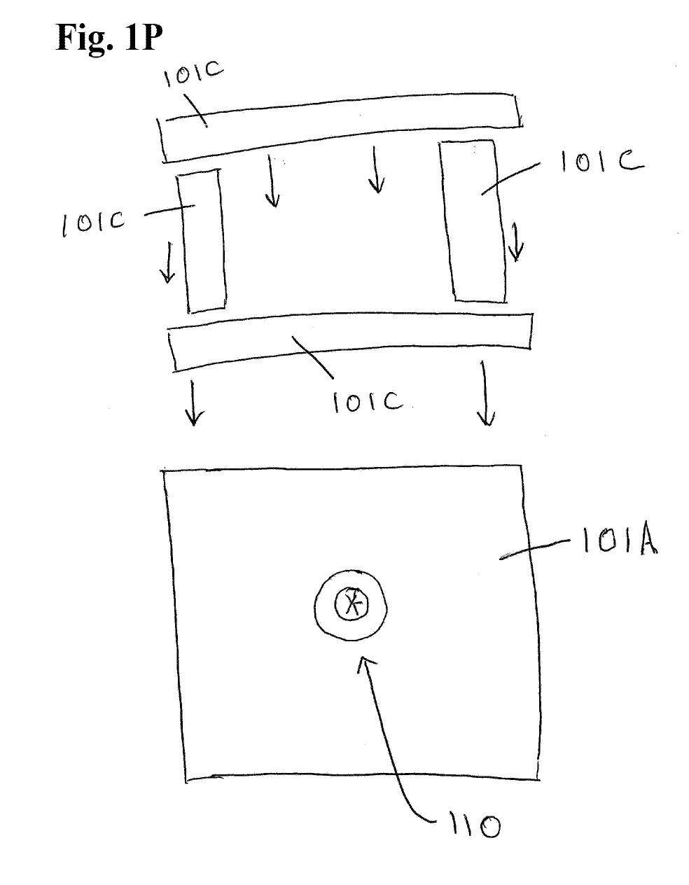

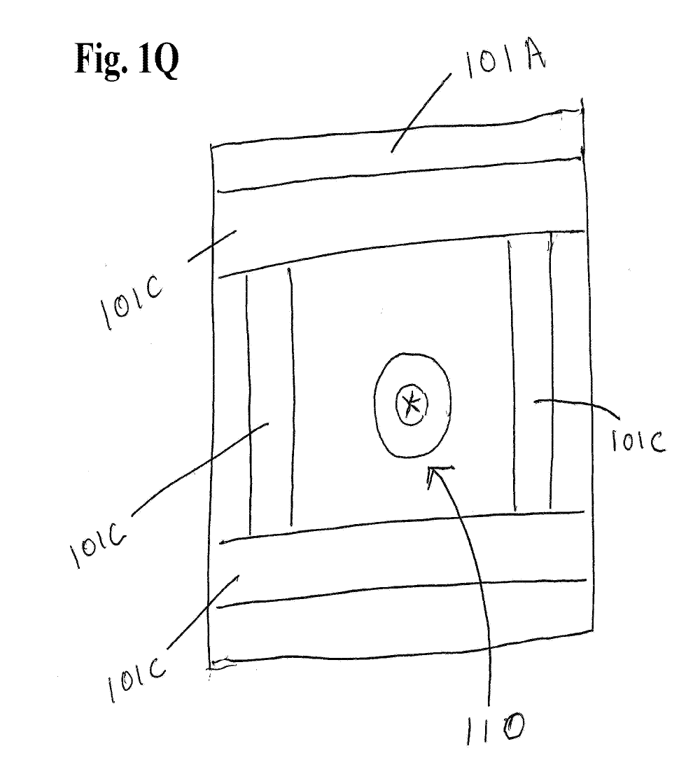

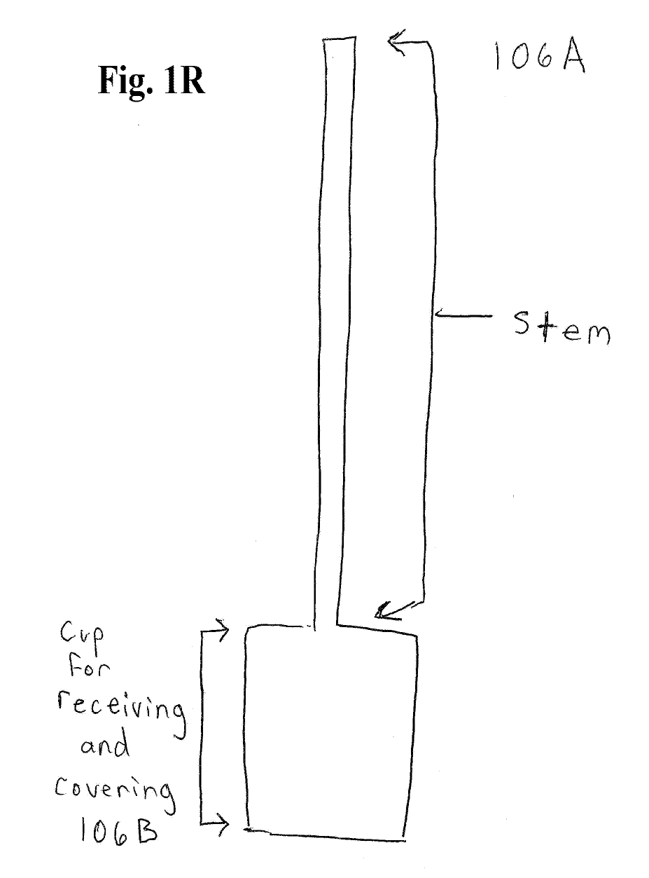

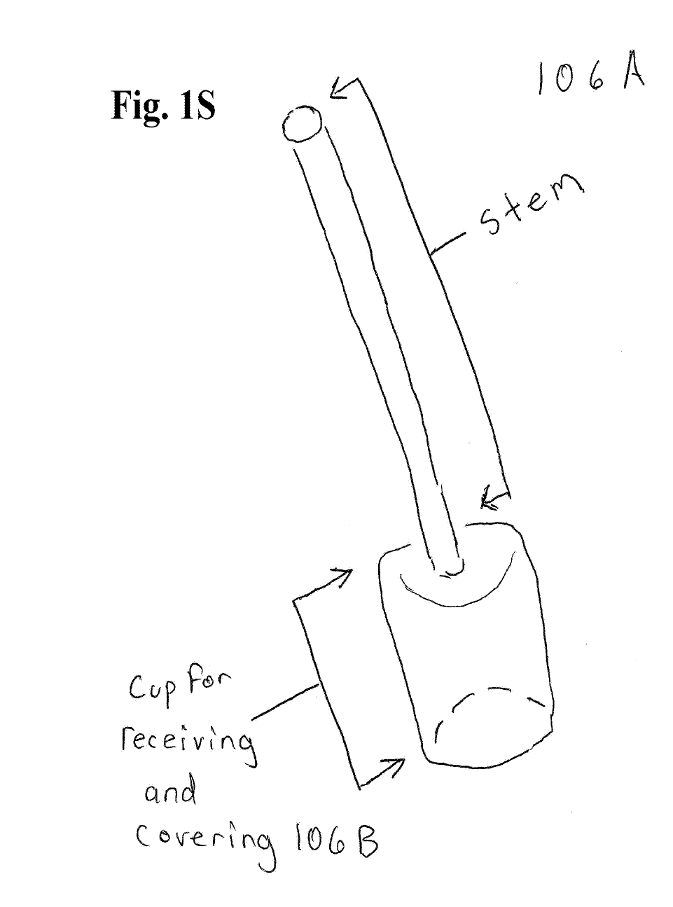

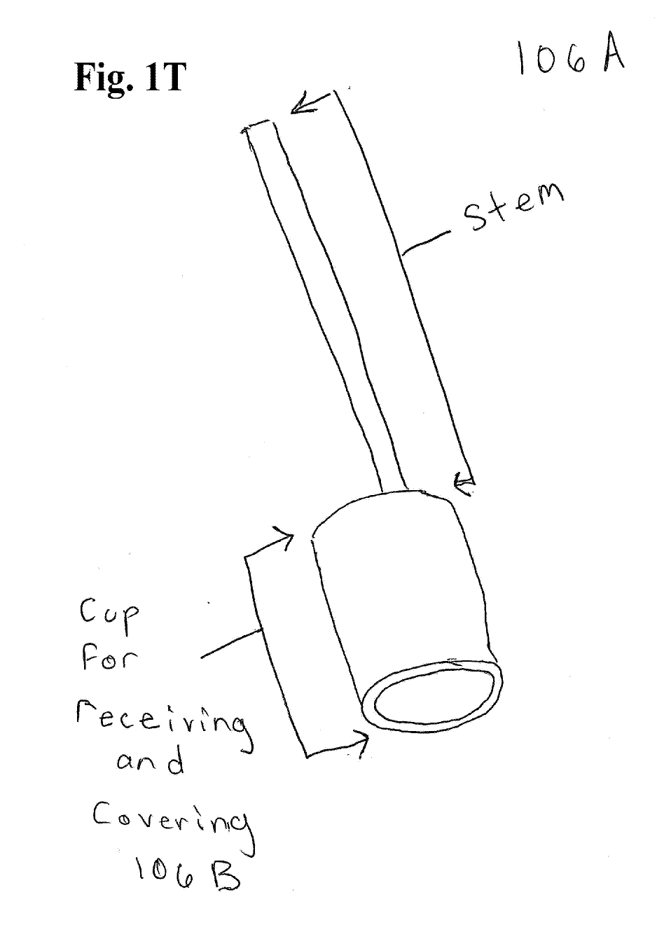

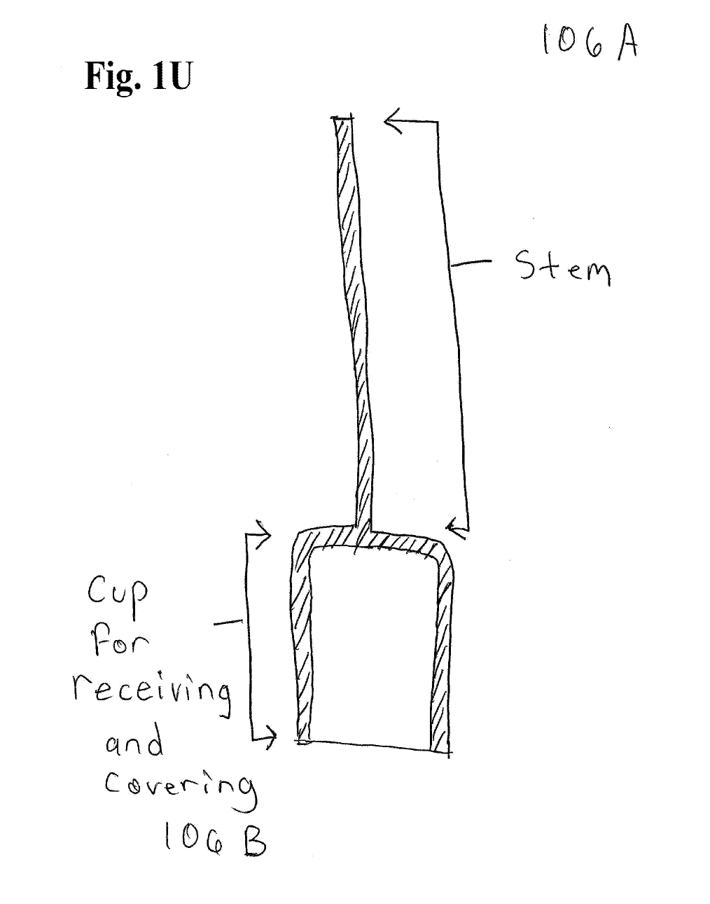

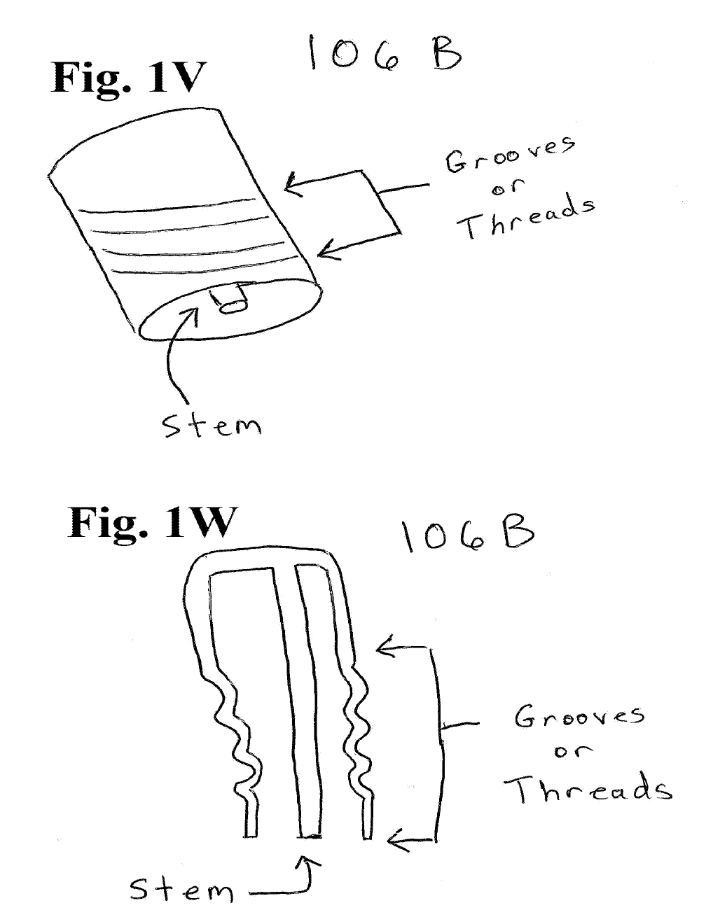

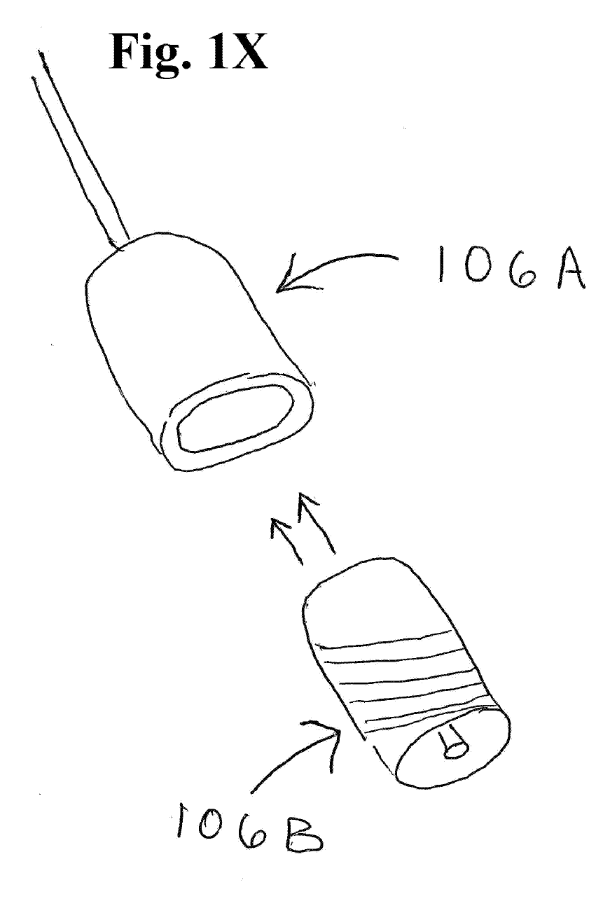

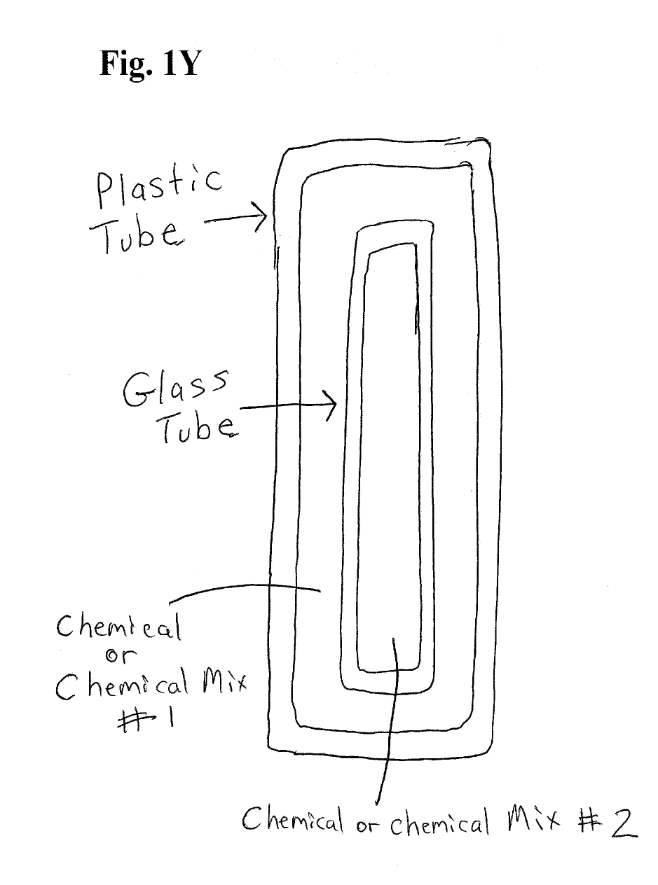

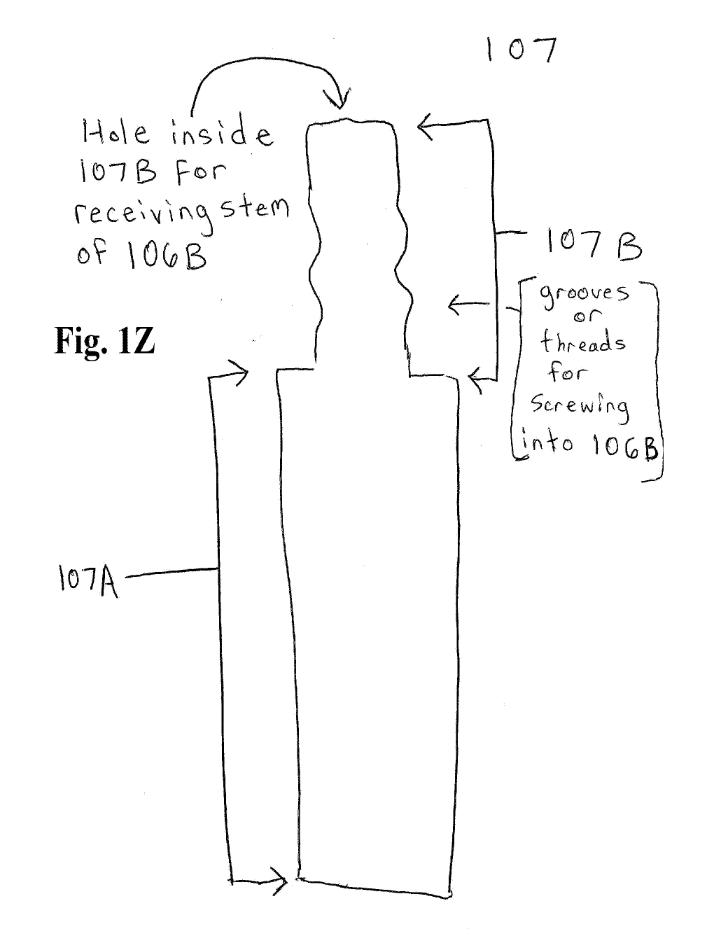

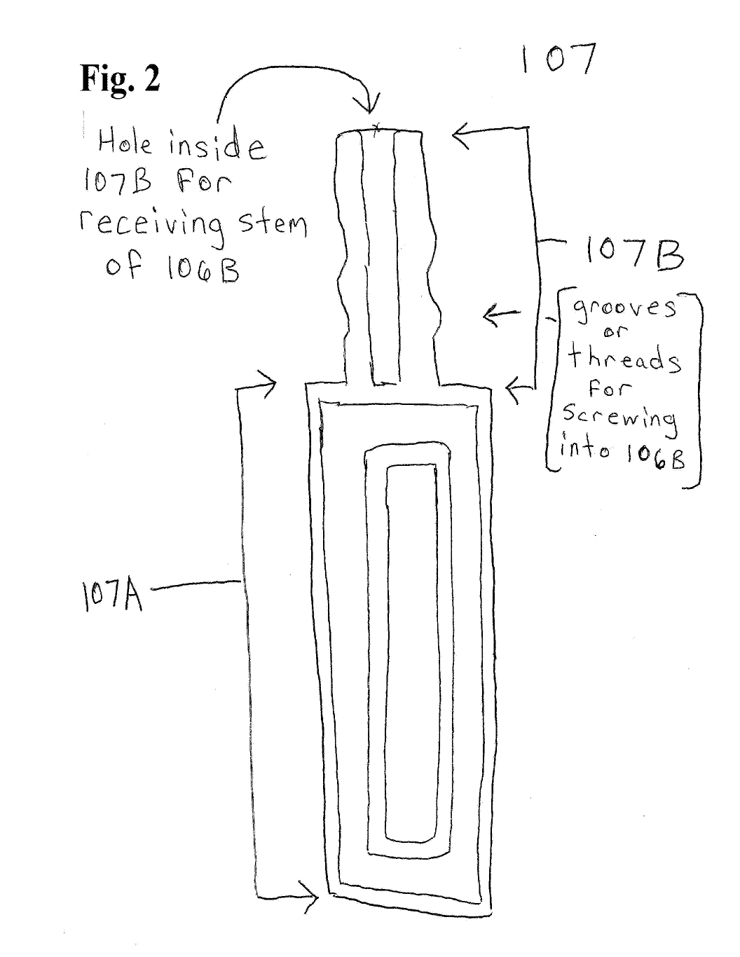

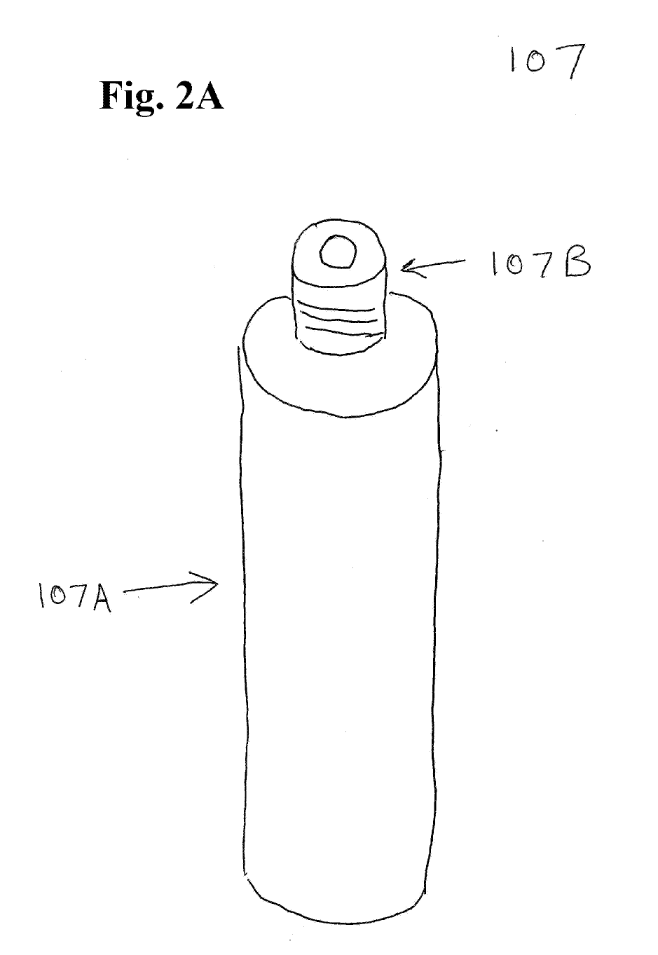

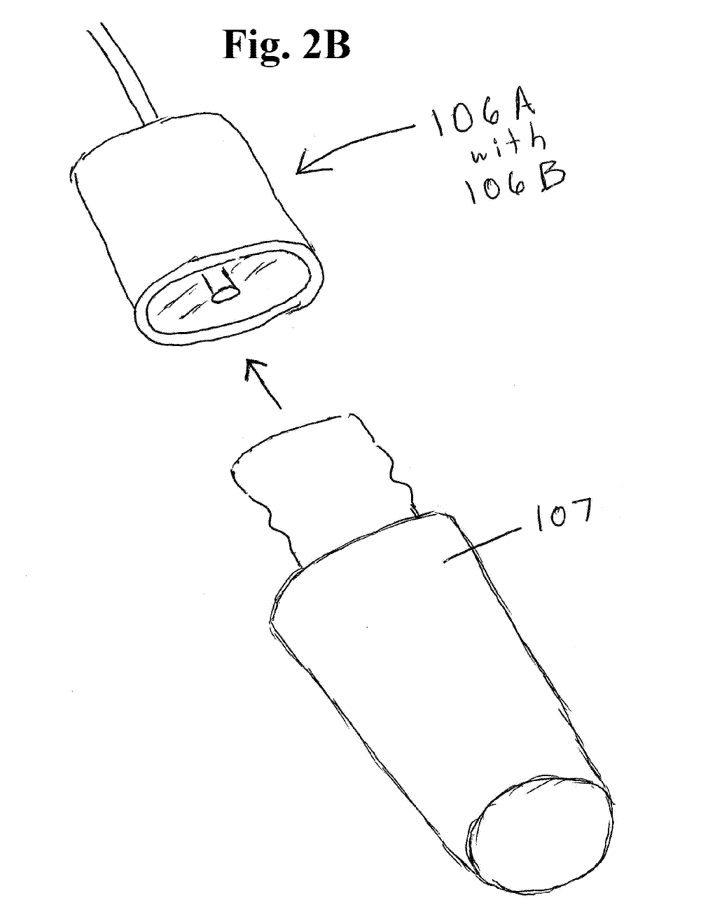

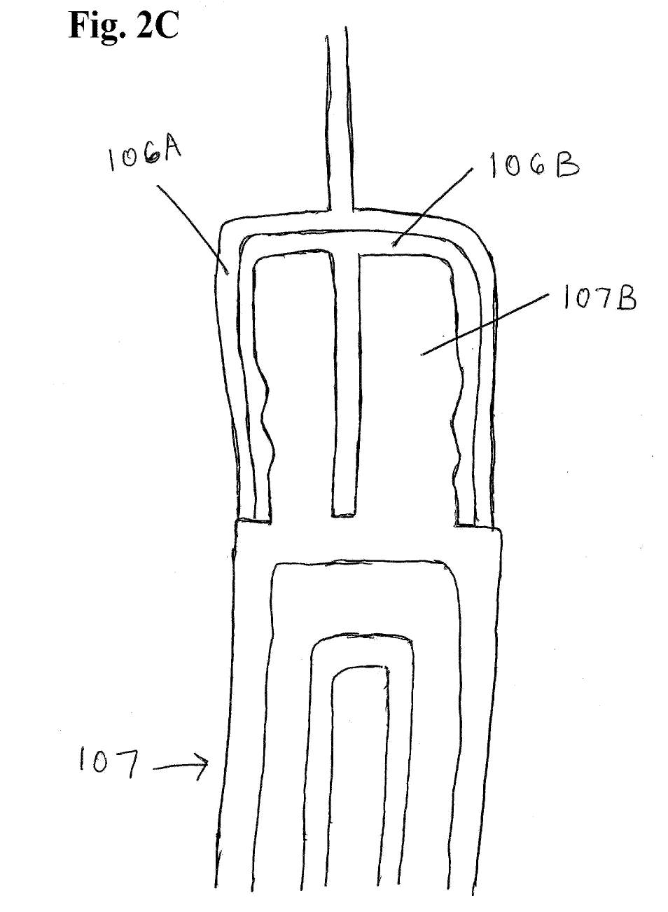

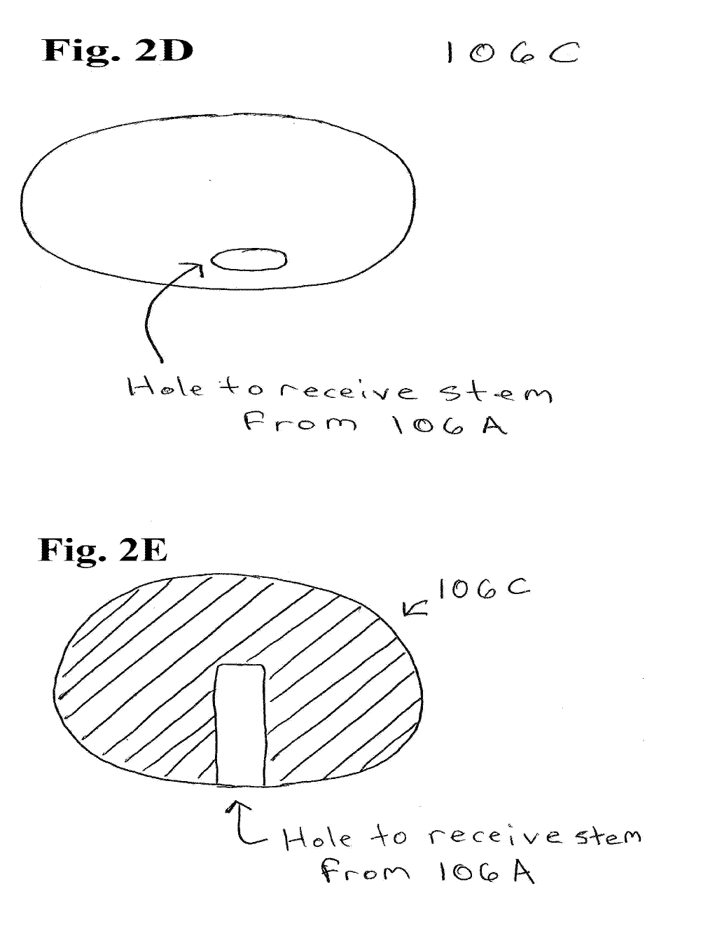

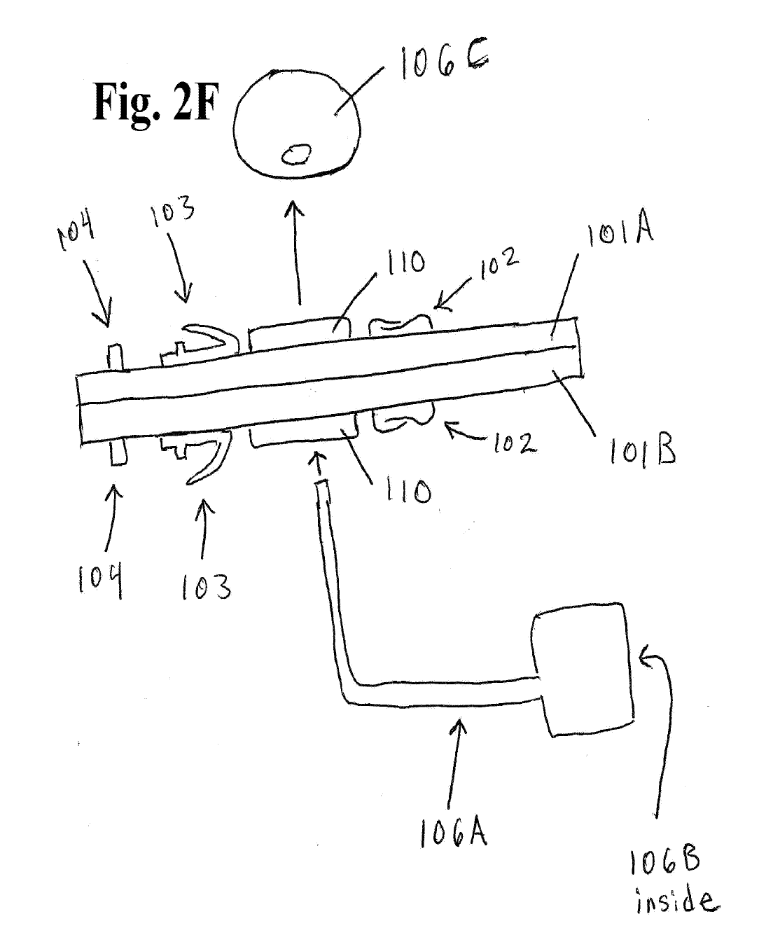

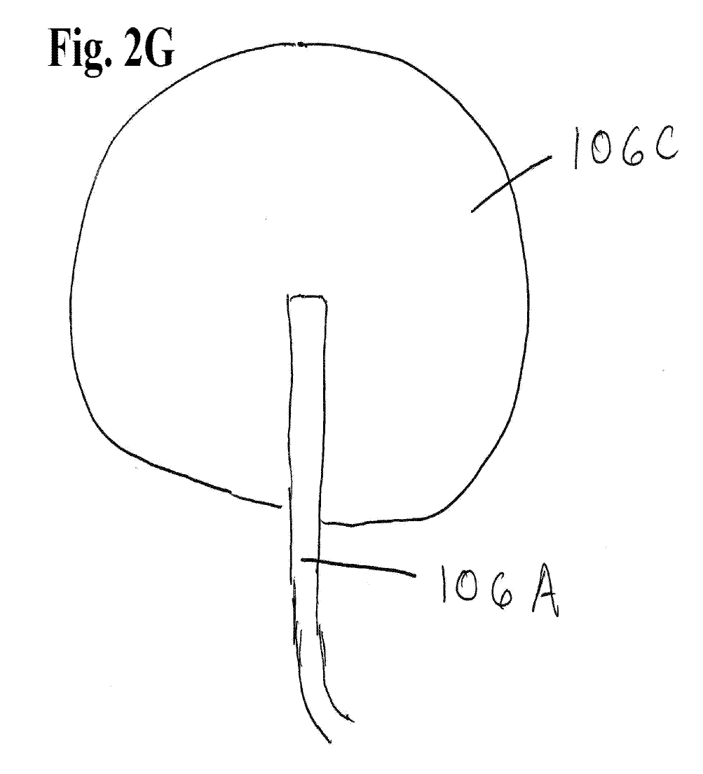

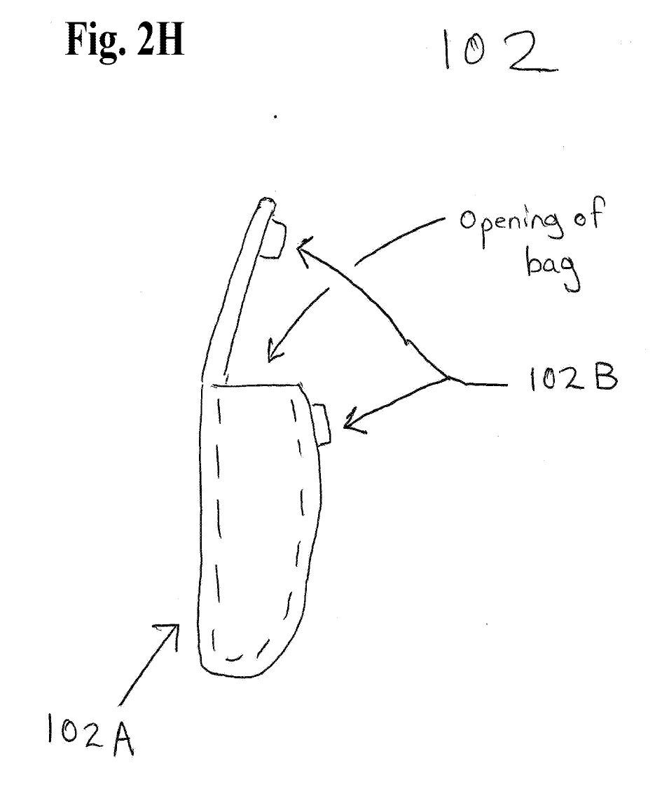

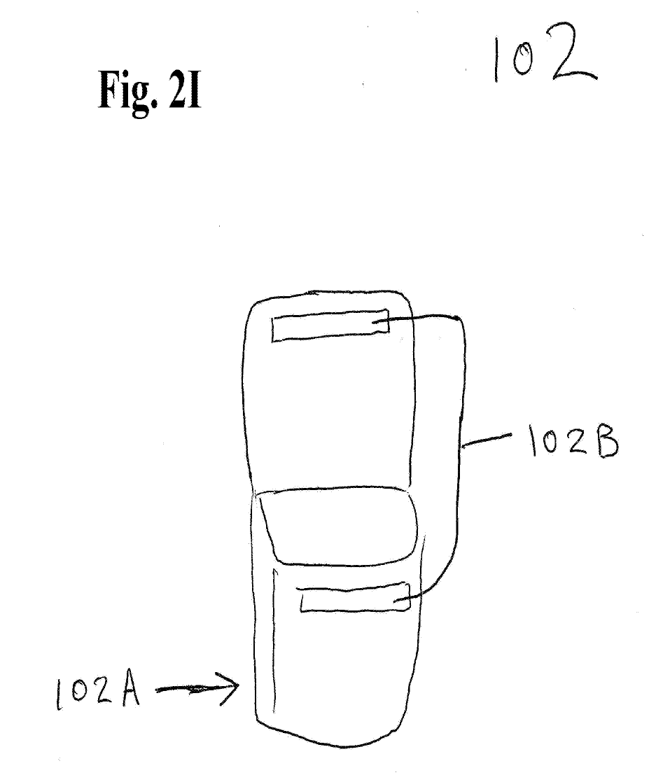

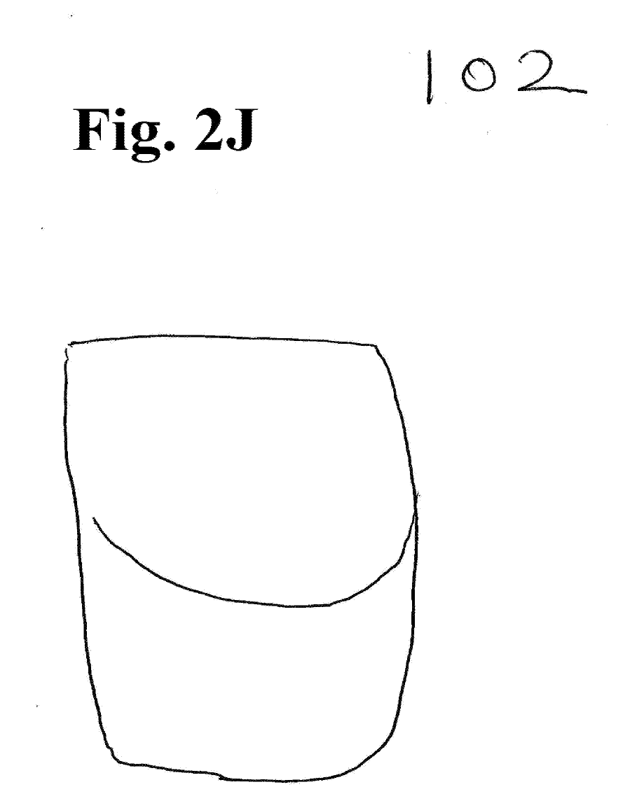

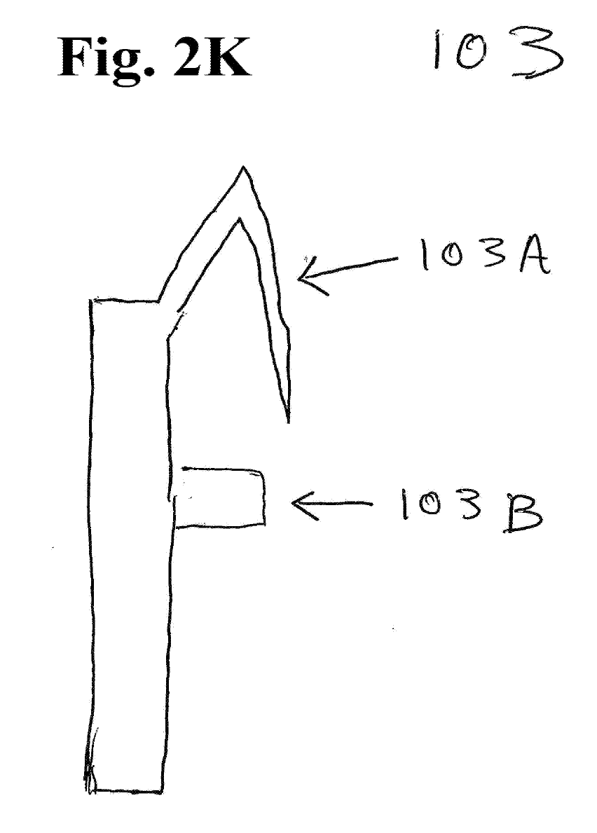

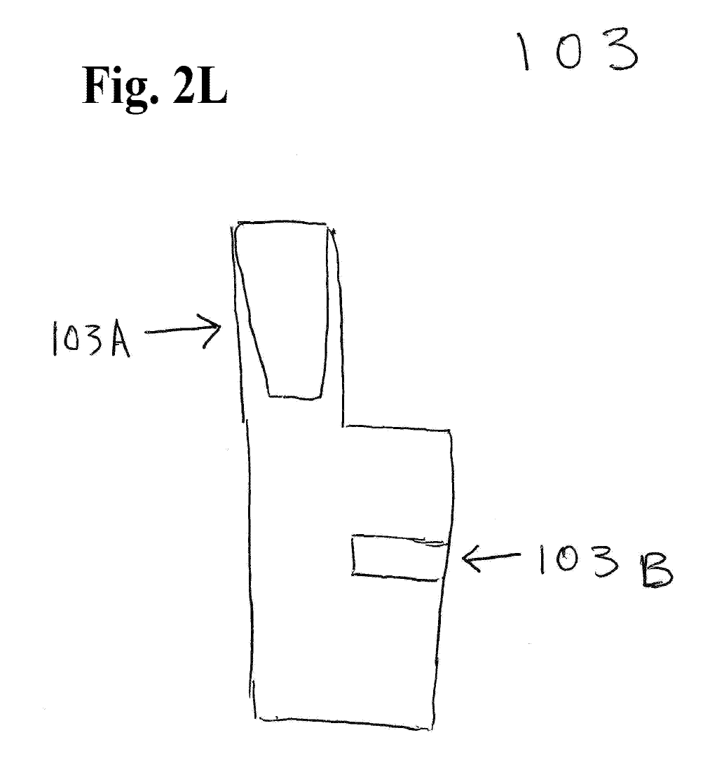

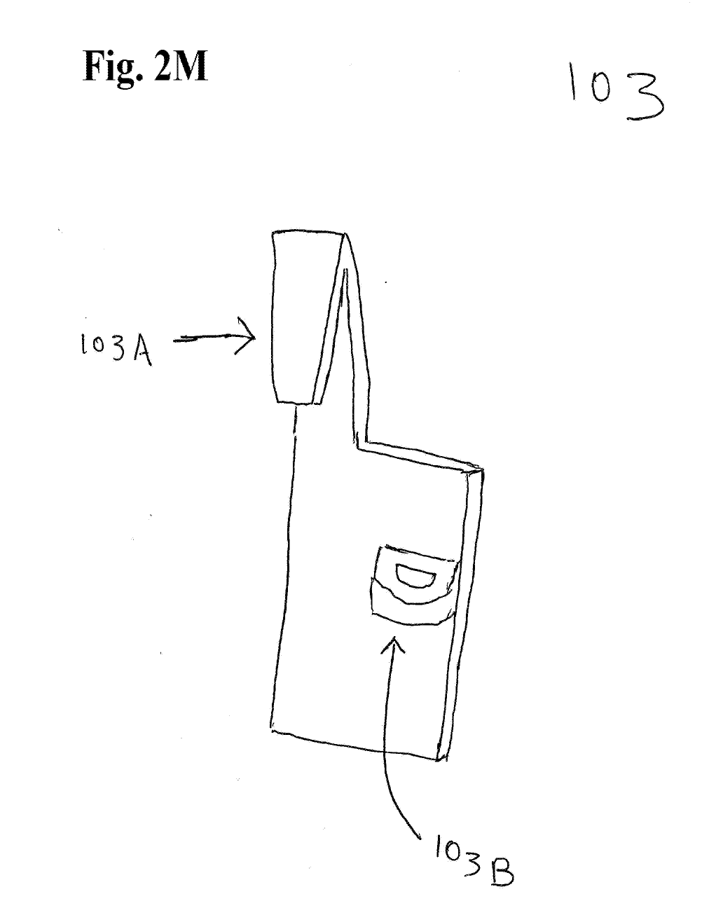

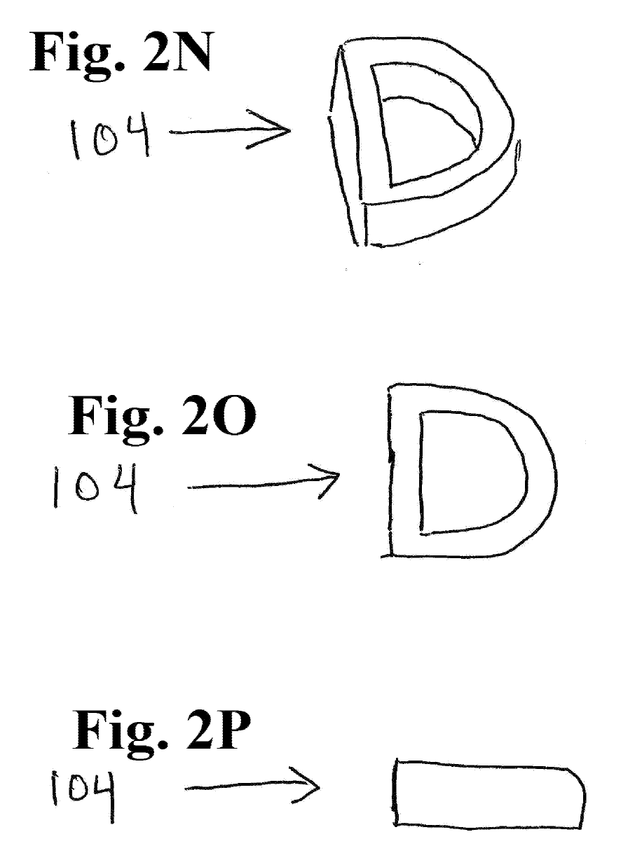

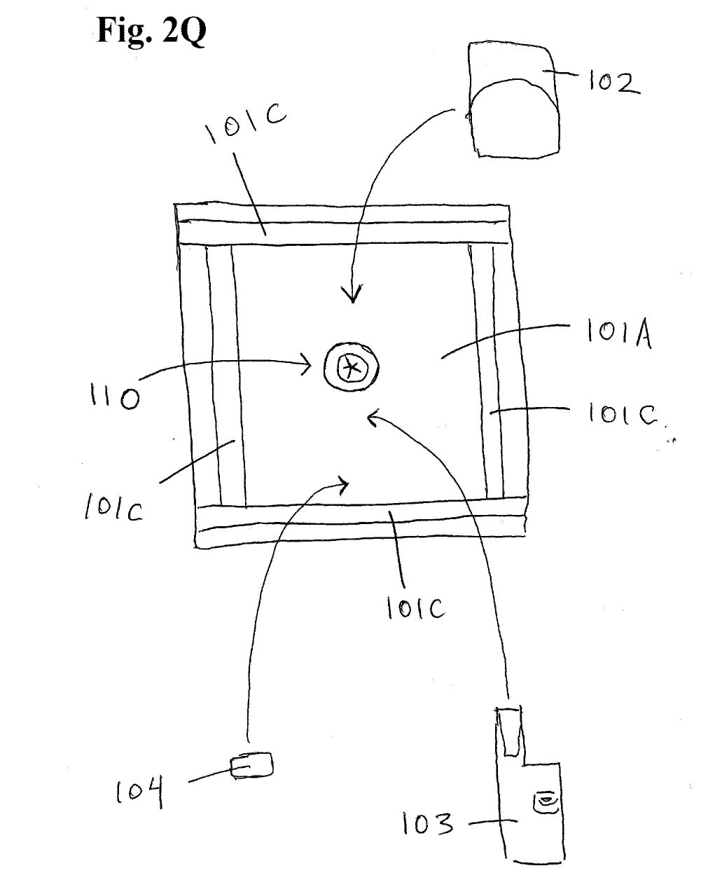

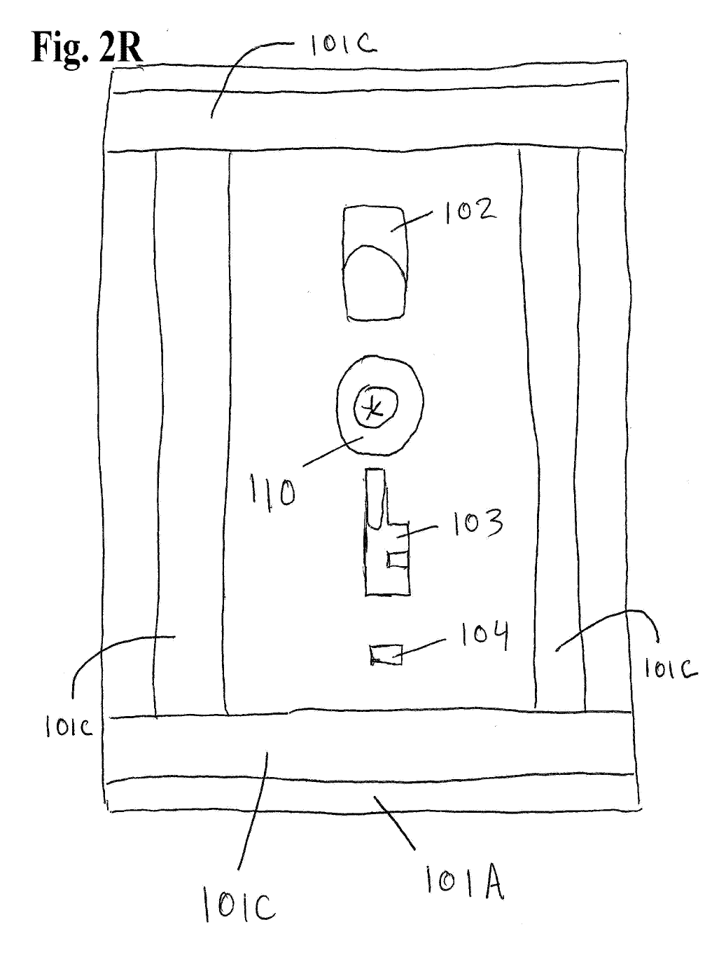

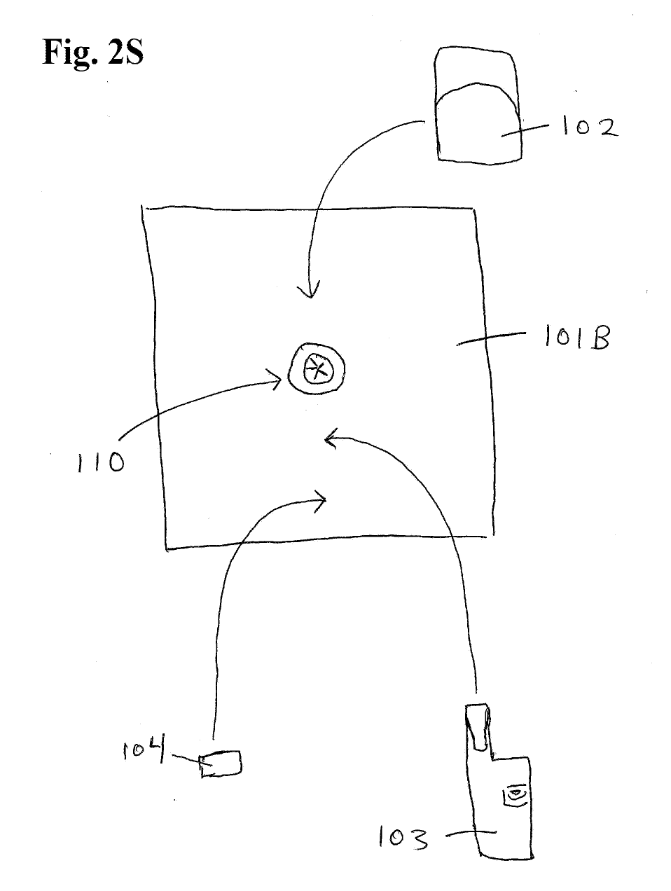

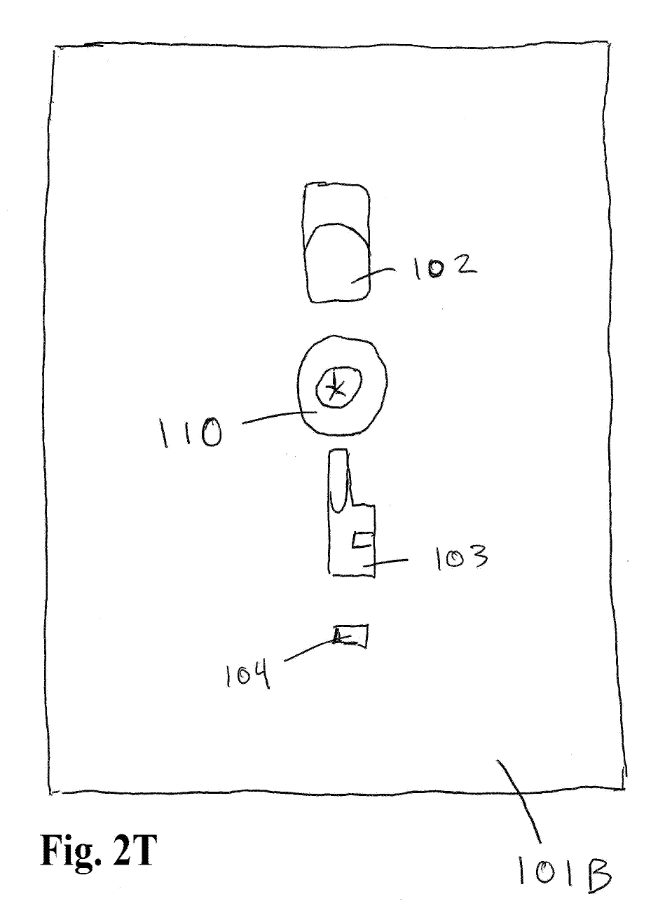

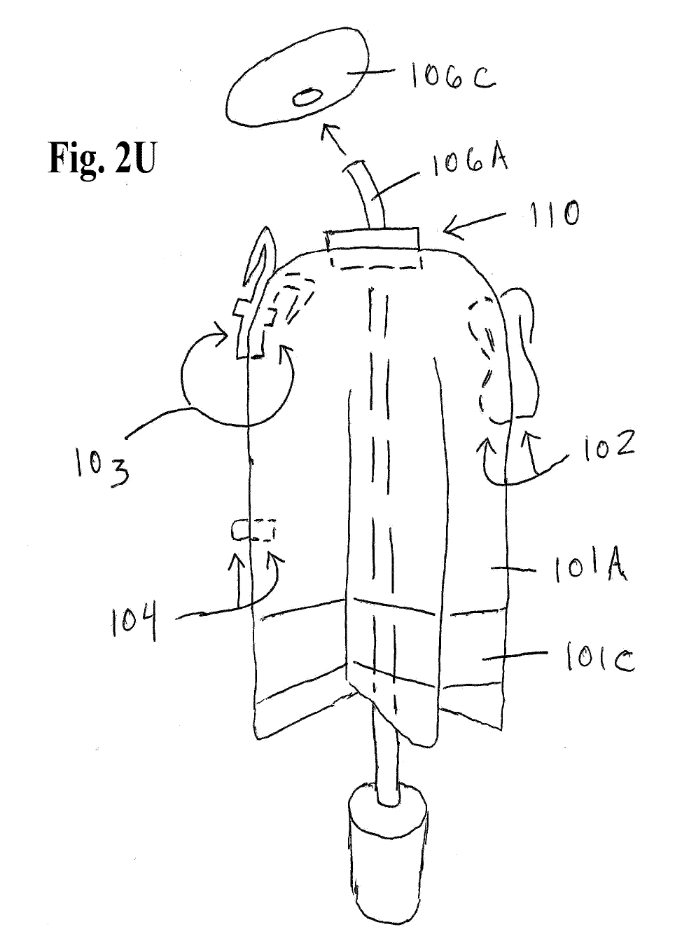

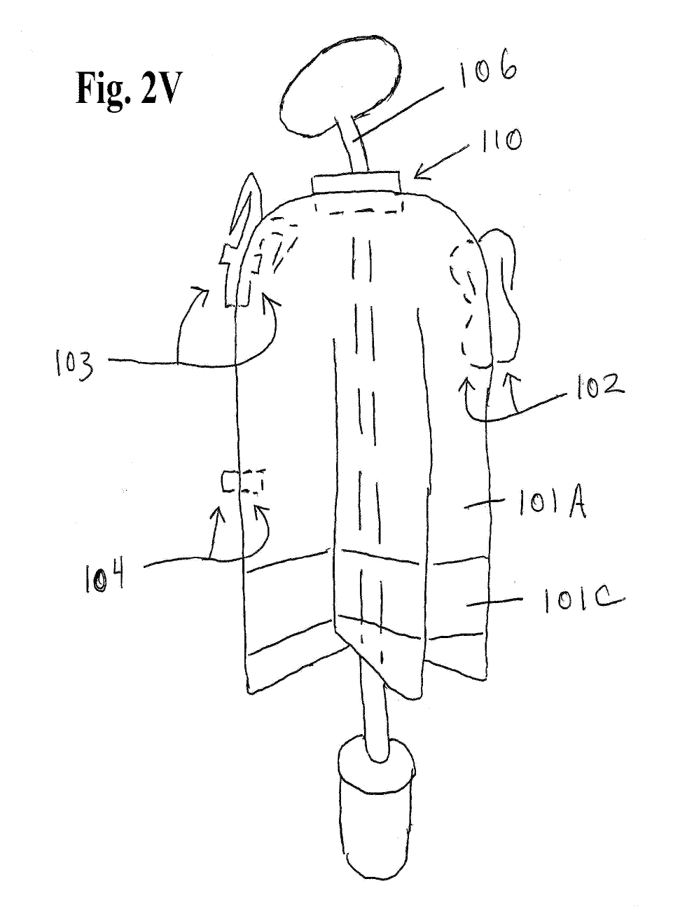

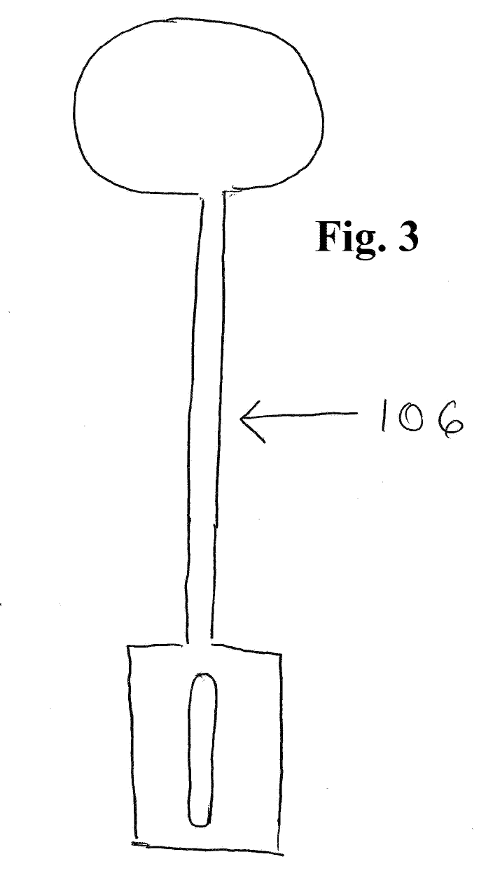

FIG. 1 through FIG. 2V shows the multi-faceted roadside motor vehicle emergency marker 100.

The multi-faceted roadside motor vehicle emergency marker 100 comprises of a marker body 101, a message sleeve 102, a motor vehicle attachment member 103, a writing utensil attachment member 104, a body rod and attachment member 106, an illuminator 107, and a grommet with teeth 110.

The marker body 101 comprises of material side 1 101A, material side 2 101B, reflective material 101C, and an opening 101D. Material side 1 101A and material side 2 101B are both preferably made up of a polyester mesh but can be made of a plurality of other materials. Some of these other materials could include plastic, cotton, nylon, or a material made from a combination of materials. Material side 1 101A can comprise of a different material than material side 2 101B. Both material side 1 101A and material side 2 101B are both preferably of a square shape but could be a plurality of other shapes Some of these other shapes could include a circle shape. Material side 1 101A preferably comprises of a florescent yellow high visibility color but could also comprise of other high visibility colors. Material side 1 101A comprises of a highly visibility color like a fluorescent yellow so that the marker body 101 can have a greater chance of being seen in both daytime and nighttime. This is just one of the colors used in some current traffic or highway safety applications because it's a color that has an increase chance of grabber someone's attention compared to some other colors. A user will want to use the high visibility side if they want to draw more attention to the marker and their motor vehicle.

Material side 2 101B preferably comprises of a dull color such as grey but could also comprise of other dull or duller colors. Some other dull or duller colors could include black or dark green. What is meant by dull is a color that is lacking brilliance or luster. These colors are duller than the color than that are to be used on material side 1 101A. Material side 2 101B comprises of a dull or duller color so that if the user chooses they can use the dull or duller side of the marker body 101 because they want to mark their motor vehicle but do not want to draw a lot of extra attention to it. Some people want to make their motor vehicle in the case of a roadside motor vehicle emergency or breakdown but just want to mark their care for safety reasons. They may want to mark it for various safety or identification reasons but not want it to be highly visible so that it will not draw a large amount of attention from passerby.

Material side 1 101A and material side 2 101B are bonded together. They are preferably sewn together but could be bonded together with adhesive. The ways of bonding material side 1 101A and material side 2 101B are not limited to these two ways mentioned. After material side 1 101A and material side 101B are bonded together an opening 101D is cut in the center of the bonded materials. The purpose of the opening 101D is to receive the grommet with teeth 110. After the opening 101D is made the area at and near the opening 101D is bonded (preferably sewn, but could be bonded via adhesive . . . but not limited to these two choices) to ensure that both materials are held together when it meets with the grommet with teeth 110. The location of the opening 101D is not limited to being placed in the center. The opening 101D is preferably a circle shape but can be a plurality of other shapes.

Once the multi-faceted roadside motor vehicle emergency marker 100 is completely put together or made then the user will be able to choose between a high visibility marker (with the aid of material side 1 101A and reflective material 101C) or a duller color marker (with the aid of material side 2 101B). The user can just reverse the maker to whichever they choose.

Both material side 1 101A and material side 2 101B serve as a signal. Material side 1 101A serves as a high visibility signal. Material side 2 101B serves as a signal that is dull or is of a color that is duller than the color of material side 1 101A. The signal is flaccid. By flaccid it is meant that the signal is not self supporting. The signal drapes about itself and drapes about the body rod. The signal is substantially planar. The signal is also pliable. By pliable it is meant that the signal could be easily bent, shaped, or moved.

After the two material sides are bonded together an opening 101D is made in the center as previously mentioned. After this opening 101D is made the grommet with teeth 110 is then inserted inside of it. The grommet with teeth is inserted into the opening 101D by hand but can be inserted into the opening 101D by other means. One of these other means could include using a grommet insertion device to insert the grommet into the opening 101D. When the term “bonded materials” is referenced in the remainder of this detailed description section it is referring to 101A and 101B that are bonded as previously mentioned above. The opening 101D that is placed in the center of the bonded materials preferably has a diameter that is smaller than the diameter of the inner diameter of the grommet. This is so that there can be a snug fit once the grommet is placed within the opening 101D. The size of the opening 101D in the center of the bonded materials could have a plurality of other diameters.

There are a variety of purposes for the grommet with teeth 110. The grommet with teeth holds the marker body 101. As the grommet with teeth moves up and down the body rod it allows the marker body 101 to be moved along with it. The grommet with teeth 110 also serves in protecting the area near the hole of the bonded materials from wear and tear during the use of this device. The teeth of the grommet with teeth 110 is located in the center. The location of the teeth of the grommet is not limited to the center of the grommet. The teeth can be made from five cuts that meet each other in the middle. The numbers of cuts is not limited to this number nor are the cuts limited to this configuration. There are preferably five teeth but is not limited or restricted to this number. The teeth are preferably a “V” shape but are not limited to this shape.

The grommet with teeth 110 is made of rubber but could be made of a plurality of other materials. Some other materials the grommet could be made of could also include metal, plastic, or a combination of materials. The grommet with teeth 110 is preferably circular in shape but could be a plurality of other shapes. The grommet with teeth 110 has a thickness thick enough that can allow it to have an inner groove diameter sizable enough to receive the bonded materials when the grommet is inserted into the hole of the bonded materials. The inside of the inner groove diameter could be lined with an adhesive to give the bonded materials extra bonding to the grommet.

The teeth of the grommet with teeth 110 rubs against the body rod and restricts a degree of movement of the grommet and attached marker body 101 as the multi-faceted roadside motor vehicle emergency marker is being used. The teeth of the grommet with teeth 110 also helps the grommet and attached marker body stay in place where the user moves it and wishes it to be as they use it.

After the grommet is inserted into the bonded materials reflective material 101C is then bonded to the material side 1 101A side of the bonded materials. The reflective material is preferably a sew on reflective fabric that is sewn onto material side 1 101A. The reflective material 101C is preferable a made of a reflective fabric but can be a reflective film, reflective tape, or a plurality of other reflective materials. The reflective material 101C is sewn onto material side 1 101A but can be bonded to material side 1 via a plurality of other methods. One method can be using adhesive to bond the reflective material 101C to material side 1 101A. The reflective material 101C is preferably in the shape of elongated strips but could comprise of a plurality of other shapes and sizes. The reflective material can be placed in any directions or patterns. One of the purposes of the reflective material 101C is to give the multi-faceted roadside motor vehicle emergency marker 100 is reflective feature. Another feature of the reflective material 101C is that it will also work with the high visible color of material side 1 101A to increase the probability of catching the attention of passerby.

After the reflective material 101C is applied to material side 1 101A then the message sleeve 102, motor vehicle attachment member 103, and writing utensil attachment member 104 are bonded to each sides of the bonded material. A message sleeve 102, motor vehicle attachment member 103, and writing utensil attachment member 104 is applied to both sides (material side 1 101A with reflective material 101C and material side 2101B). Afterwards the stem of terminal obstruction member with stem 106A (with illuminator receiving socket 106B attached) is inserted through the grommet with teeth 110. After the stem is placed through the grommet with teeth 110 then terminal obstruction member 2 106C is attached to the end of the stem. Once the terminal obstruction member with stem 106A is attached to the terminal obstruction member 2 106C the body rod and attachment member 106 is created.

The terminal obstruction member with stem 106A comprises of a socket or cup like member with a stem extending from the center of the closed end (from the inside of the socket). The socket or cup like portion serves to obstruct or block the grommet with teeth 110 as it moves the marker body about the body rod and attachment member 106. The terminal obstruction member with stem 106A obstructs the grommet with teeth 110 because the diameter of the socket or cup like portion of the terminal obstruction member with stem 106A is larger than the of the inner diameter of the grommet with teeth 110. The terminal obstruction member with stem 106A is made preferably of rubber but could be made of a plurality of other materials. Some of these other materials could include plastic, or a combination of materials. Another purpose of the socket or cup like end of the terminal obstruction member with stem 106A is to receive and hold the illuminator receiving socket 106B. The illuminator receiving socket 106B receives the illuminator 107.

The illuminator receiving socket 106B is a piece of metal shaped like a light bulb socket. This socket preferably has a flat closed end but could have a closed end of other shapes or configurations. This socket is different than the traditional light bulb socket because there is a stem in the middle inside of it. The whole socket is made of metal but can be made of a plurality of other materials. The diameter of the socket is the same size of less than that of the socket or cup like portion of the terminal obstruction member with stem 106A. The illuminator receiving socket 106B is inserted into the socket or cup like member of the terminal obstruction member with stem 106A. The closed end of the illuminator receiving socket 106B is inserted first into the socket or cup like member of the terminal obstruction member with stem 106A. The stem within the illuminator receiving socket 106B will fit into the hole in the middle of the grooved or threaded end of the illuminator 107 that is to be received. The stem of the terminal obstruction member with stem 106B is preferably circular but can have a plurality of other shapes. The stem of the terminal obstruction member with stem 106b preferably has a length that is atleast long enough that it can be carried through the grommet with teeth 110 and the end of the stem entered into the hole of the terminal obstruction member 2 106C. But the length of the stem of the terminal obstruction member with stem 106b can be other lengths. The hole in the middle of grooved or threaded end of the illuminator 107 will have a shape the same as the shape of the stem of the illuminator receiving socket 106B. This stem is a elongated piece that stems or sticks out from the middle inside of the illuminator receiving socket 106B. The illuminator receiving socket 106B has threads or groves that will allow the illuminator 107 to be screwed into it. It is preferable that the threads or grooves of the illuminator receiving socket 106B are designed so that the illuminator 107 will need to screw into the illuminator receiving socket 106B counter-clockwise to tighten. But the threads or grooves of the illuminator receiving socket 106B can be design for the illuminator to be screwed in and tighten by a clockwise rotation. The design or direction of the threads or grooves is not limited to these two descriptions.

The illuminator 107 comprises of a preferably a glowstick. This is also sometimes called a chemiluminescent (or sometimes called “chemoluminescent”) lighting device. A glowstick illuminates due to a reaction of certain chemicals. A glowstick is a single use translucent plastic tube that contains isolated chemicals that emit illumination when mixed. The plastic tube is bent until the inner glass tube is broken. When the inner tube is broken the chemicals mix to produce a chemical arrangement that produces illumination. The illuminator 107 is preferably a glowstick but can be a plurality of other lighting devices. The illuminator 107 is self source illuminator. What is meant by self source illuminator is that it can illuminate without the use of electricity. The illuminator 107 could also be a light that operates by a battery. Self source could also mean a device that illuminates by a self contained power source such as a battery.

The illuminator 107 is preferably elongated with a circular diameter shape but can be a plurality of other shapes. The diameter of the illuminator body 107A is preferably the same diameter of the outside diameter of the socket or cup like end of the terminal obstruction member with stem 106A but could also be a plurality of other diameters. The illuminator body 107A contains the chemical arrangement that when mix produces illumination. This illumination can be chemical induced. The illuminator body 107A is preferably made of a translucent plastic material but could consist of a plurality of other materials. The illuminator body 107A is flexible enough so that the hand can bend it enough to break the glass tube within it. The inside of the illuminator body 107A preferably holds Hydrogen Peroxide. The glass tube is preferably placed inside the illuminator body 107A. The glass tube that is placed within the illuminator body 107A preferably contains a mix of phenyl oxalate and a fluorescent dye solution. The illuminator body 107A is not limited to this particular mix of chemicals, chemical arrangement, or setup and can be arranged differently. Different chemicals could be used as well to produce a chemical induced illumination. To have the illuminator 107 produce the illumination the user bends the plastic illuminator body 107A enough to break the glass tube within it. When the glass tube is broken the chemicals mix and produce an illumination. A purpose of the illuminator 107 is to attach to and be a component of the multi faceted roadside motor vehicle emergency marker 100. One purpose of the illuminator 107 is to emit light to attract passerby attention and to provide illumination near the marker. The illuminator 107 can also illuminate from within the marker body or it can illuminate outside of it. One advantage of the illuminator component of this present invention is to be able to grab or catch passerby attention that are far away, or going in many different directions . . . . Including directions other than towards the marker and the broken down motor vehicle.

The illuminator screw end for the illuminator receiving socket 107B comprises of a threaded or grooved end at an end of the illuminator body 107A. This end of the illuminator 107 has a hole within it. The hole is to receive the stem that is within in the illuminator receiving socket 106B that is located within the terminal obstruction member with stem 106A (after they are joined together). The diameter of the illuminator screw end for the illuminator receiving socket 107B is preferably smaller than the diameter of the illuminator body 107A. But the diameter of the illuminator screw end for the illuminator receiving socket 107B can be a plurality of sizes. The diameter is preferably the same shape of the illuminator receiving socket 106B The illuminator screw end for the illuminator receiving socket 107B has threads of grooves on the outside of it. This is so it can be screwed into the illuminator receiving socket 106B found within the terminal obstruction member with stem 106B. The pattern of the threads or grooves of illuminator screw end for the illuminator receiving socket 107B are patterned to synchronize with the threads or grooves of the illuminator receiving socket 106B. This allows the illuminator screw end for the illuminator receiving socket 107B to be received and held by the illuminator receiving socket 106B located within the terminal obstruction member with stem 106A. The illuminator screw end for the illuminator receiving socket 107B is preferably made of plastic like the illuminator body 107A but can also be made of a plurality of other materials.

The terminal obstruction member 2 106C is a rubber ball with a hole within the bottom center of it. It can be made of other materials and can consist of other shapes. It is preferable that the hole does not go through both sides of the rubber ball but it is not limited to this configuration. The purpose of the hole in the bottom of the rubber ball is to receive the end of the stem of the terminal obstruction member with stem 106A that is opposite the end with the socket or cup like feature. The end of the stem that is to go within the hole of the rubber ball is connected within this hole after it goes through the grommet with teeth 110 that is attached to the marker body 101 or signal. It is preferable that the end of the stem is bonded within the hole with adhesive. It can be secured within the hole by a plurality of other methods. Just like the socket or cup like portion of the terminal obstruction member with stem 106A the terminal obstruction member 2 106C serves to obstruct or block the grommet with teeth 110 as it moves the marker body about the body rod and attachment member 106. The terminal obstruction member 2 106C is also just like the terminal obstruction member with stem 106A as it obstructs the grommet with teeth because the diameter of the rubber ball of the terminal obstruction member 2 106C is larger than the of the inner diameter of the grommet with teeth 110.

The body rod with attachment member 106 is comprised of a terminal obstruction member with stem 106A, Illuminator receiving socket 106B, and a terminal obstruction member 2 106C. The stem portion that portion of the terminal obstruction member with stem 106A serves as the body rod. The diameter of this stem is preferably smaller than the diameter of the inner diameter of the grommet with teeth 110. This is so the stem can be inserted through the grommet and the grommet can move up and down about the stem. The grommet with teeth 110 and the marker body 101 can be moved up and down the rod. At each end of the rod is an obstruction member that obstructs the movement of the grommet with teeth 110 and the marker body 110 (which is attached to the grommet with teeth 110). There are two terminal obstruction members and one can found at the each of the two ends of the rod. A portion of the rod can be used as an attachment member as it can be closed within the door. It also can be wrapped around a portion of a car wheel. It could be used with other parts of a motor vehicle as well.

The diameter of the stem portion of the terminal obstruction member with stem 106A is smaller than the inner diameter of the grommet with teeth 110 so that the grommet with teeth 110 can move about the body rod.

The message sleeve 102 is preferably comprised of a bag 102A with a selfseal 102B. The purpose of the sleeve is to contain, protect and store the message or information placed within it during the roadside motor vehicle emergency situation. The bag 102A serves by being able to contain, protect, and store the information. The bag is preferably in the shape of a container with a lid. The bag 102A is preferably made of a translucent plastic material but can be made of a plurality of other materials. One bag 102A is located on material side 1 101A and one bag is placed on material side 101B. Each bag 102A is placed near the grommet with teeth 110.

They are preferably in the same places and be back to back. The purpose of the selfseal 102B is to help seal, close, or secure the bag 102A. The selfseal 102B is preferably Velcro but can be a plurality of other selfseals. Some other selfseals could include a device such as a zipper. The two pieces of Velcro is positioned on the bag so that it helps to close the opening of the bag 102A.

The motor vehicle attachment member 103 comprises of window attachment member 103A and an antenna attachment member 103B. The motor vehicle attachment member 103 allows the multi faceted roadside motor vehicle emergency marker 100 to attach to more than one part of a motor vehicle. It is preferably made of rubber but could be made of a plurality of other materials. It is made preferably or a rectangle shape but could consist of a plurality of shapes. It is preferable that the window attachment member 103A comprise of a rubber hook that extends out from the rectangle shape. This hook would extend from the top left portion of the rectangle. The hook shape will allow the multi-faceted roadside motor vehicle emergency marker 100 to clip or hang onto a motor vehicle window. The antenna attachment member 103B comprises of raised portion of material with a hole within it. The hole is big enough to fit around a motor vehicle antenna. The flat back side of the motor vehicle attachment member 103 is bonded to both material side 1 101A and material side 2 101B. One is placed on each side. The two motor vehicle attachment members 103 are preferably placed back to back. They are preferably located near the grommet with teeth 110. They are preferably located on the side of the grommet opposite the side that the message sleeve 102 is located on. This is so that when the multi faceted roadside motor vehicle emergency marker 100 is placed on a window or antenna the front end of the marker will have the message sleeve 102 which will contain the information left by the user.

A purpose of the writing utensil attachment member 104 is to hold or fasten a writing utensil to the marker body 101. The writing utensil attachment member 104 is preferably a “D” shaped piece of rubber. It is not limited to this shape and can be a plurality of other shapes. Some of the other shapes could include an “O” shape. It is not limited to being rubber and can be made of a plurality of other materials. Some of the other materials could include plastic, metal, cord, or a combination of other materials. It is also preferred that the writing utensil attachment member 104 have some elasticity so that it can be pulled or stretched enough to place a writing utensil within the attachment and also be able to take the writing utensil out of it. The writing utensil attachment member 104 is placed on material side 1 101A and material side 2 101B. One is placed on each side. They are preferably placed on them with an adhesive such as glue but can be attached to material side 1 101A and material side 2 101B via being sewn on or by a number of other methods. The flat part of the D side is bonded on the marker body 101. One is placed on each side of the marker body 101 (on parts 101A and 101B). They are preferably placed back to back. They are also preferably placed below the motor vehicle attachment member 103.

When there is a roadside motor vehicle emergency a user can use the present invention by taking the writing utensil that is placed in the writing utensil attachment member 104, write down information pertinent to the motor vehicle's condition or emergency situation and then place their information or their message into message sleeve 102. After this the user then can attach or affix the multi-faceted roadside motor vehicle emergency marker 100 to a one of a number of motor vehicle components that it can attach or affix to. They can attach it on the motor vehicle side window. They could place it on an antenna on their motor vehicle. They could enclose a part of the body rod in between a door or another area of the motor vehicle that closes. They could also use a part of the body rod and tie it around a part of the motor vehicle. The user is not limited to just these ways of attaching the marker or signal to their motor vehicle.

The user can have a choice of the level or visibility that they want. They can have a side that his reflective and has a high visibility. Or they can turn it upside down and reverse to a dull or duller side. Each side has its own message sleeve 102, motor vehicle attachment member 103, and writing utensil attachment member 104. As the user reverses the marker between the two different sides they can adjust the body rod. The side that is reflective and has a high visibility color have two ways of drawing passerby attention. This is because it has a reflective material attached and also have a color that is provides a higher visibility. The reverse side of the marker has a dull color or color that is duller than the high visibility color. This allows the user to be able to use the present invention but draw less attention to their motor vehicle than it would get if it were on the reverse higher visibility side. The user can use this side (the dull or duller side) for if they just want to use some of the other features of the marker but not draw too much attention to their motor vehicle.

The reflective side of the marker makes it highly visible to the people who pass by, especially in the darker times of the day. The high visibility color also helps to make it stand out during the day and during the night. By this side being a florescent yellow it could be seen in the day and the night (this side of the marker is not limited to this color).

When people pass by they are alerted to the motor vehicle emergency and if they choose they can go check the information or message that is contained in the message sleeve 104. The passerby can also choose to place a message in the message sleeve 104 also. The present invention allows the user to leave information or a message at the scene of the motor vehicle emergency and have it protected from blown away in the wind, ruined by the rain, or other scenarios. It also allows the user to place the marker in plurality of places other than on the motor vehicle window or on the ground.

The user can attach a writing utensil to the marker or signal so that they can have one readily available to them in the case of a roadside motor vehicle emergency or breakdown. The user can use the writing utensil to leave a message or a passerby could also use the writing utensil to leave a message.

The user can also increase the visibility of the marker because it also has an illuminator 107. The reflective feature and the high visibility color feature will aim to catch the attention of passerby but the illuminator 107 increases the chances of the marker being seen. While the reflective material 101C and the high visibility color gives the marker a high profile the illuminator 107 can also serve as a more proactive or active emitter of light. This feature can really be helpful when the motor vehicle is a distance away from the roadside and it is becoming darker outside. If the motor vehicle is further away from roadside then the less the chances of passerby seeing it. The illuminator part of the marker can illuminate light to increase the chances of catching passerby attention as each passerby may not be passing by at a distance near enough or not traveling in a direction of the motor vehicle. The illuminator 107 will seek to increase the chances of catching the attention of passerby going in other directions or areas that are opposite of where the motor vehicle is located. The user can screw in the illuminator 107 so that it is secure and attached to the other parts of the marker.

The present invention is called multi-faceted because it provides a plurality of features or facets. The terminal obstruction member with stem 106A, motor vehicle attachment member 103, terminal obstruction member 2 106C, and illuminator 107 can be made from a mold. These items are preferably made of rubber but can be made of other materials. The illuminator 107 is preferably made of plastic but can be made of other materials. The illuminator 107 of the present invention can be made from a mold, or be made by a manufacturer of illuminators. The illuminator screw end for illuminator receiving socket 107B portion of the illuminator 107 is molded to the type of socket (illuminator receiving socket 106B) that it will fit into. The grommet with teeth 110 can be made from a mold, or could be made by a manufacturer of grommets.

The socket that is to be used for the illuminating receiving socket 106B can be made from a mold or could be made manufacturer of light bulb sockets. This socket can be used to help make the mold of the illuminator screw end for illuminator receiving socket 107B of the illuminator 107. This illuminator screw end for illuminator receiving socket 107B can be molded with the illuminator body 107A or it could be molded separately (from the design of the illuminator receiving socket 106B to be used) and then bonded to onto on end of a commercially available illuminator of glow stick. The other materials or parts used to make this present invention could be purchased from various places in the marketplace.

Some of the advantages of the multi-faceted roadside motor vehicle emergency marker 100 include:
providing a marker for roadside motor vehicle emergencies that can contain, display, and protect information the user needs to leave regarding the situation.
providing a marker for roadside motor vehicle emergencies that is not limited to use with an motor vehicle window.
providing a marker for roadside motor vehicle emergencies that is not limited to use on the ground.
providing a marker for roadside motor vehicle emergencies that can hold a writing utensil so that a user can write down information relating to the motor vehicle condition or the emergency situation.
providing a marker for roadside motor vehicle emergencies that has a place where a user can contain, store and protect information pertinent to the motor vehicle condition or the emergency situation.
providing a marker that gives the user a choice of varying levels of visibility and can allow the user to switch back and forth between the levels as they choose.
providing a marker that allows a choice between multiple vehicle attachment members.
providing a marker for the attachment to a motor vehicle in a roadside emergency that can provides a combination of a reflective marker and self source illuminator.

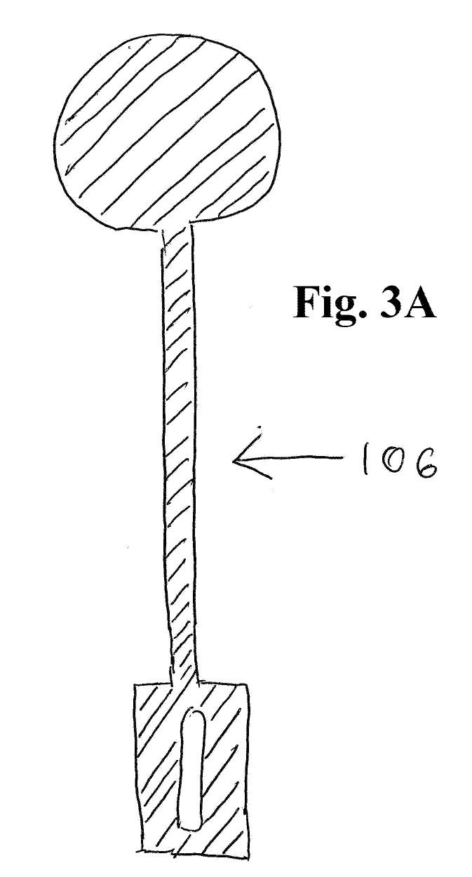

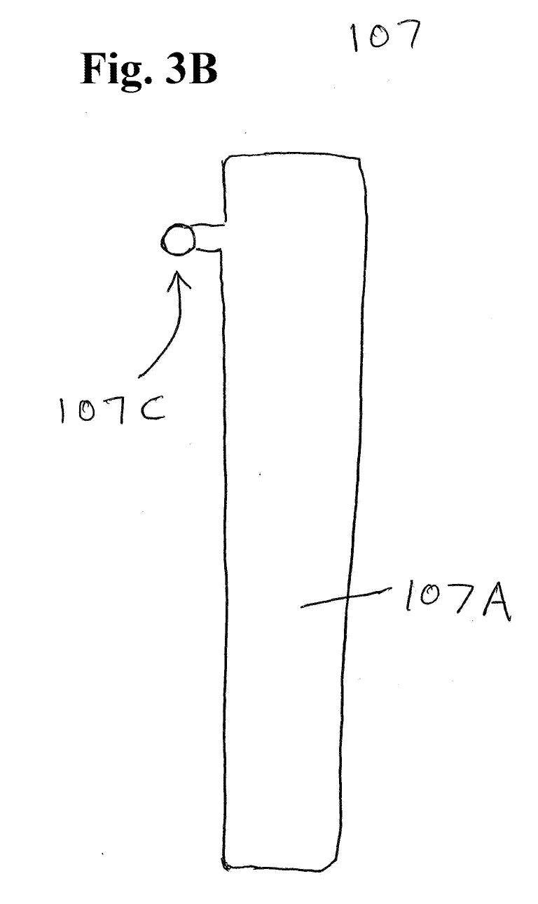

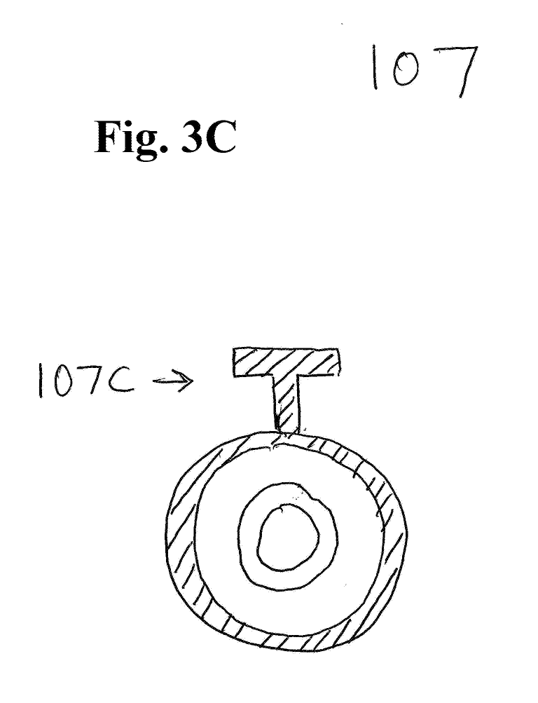

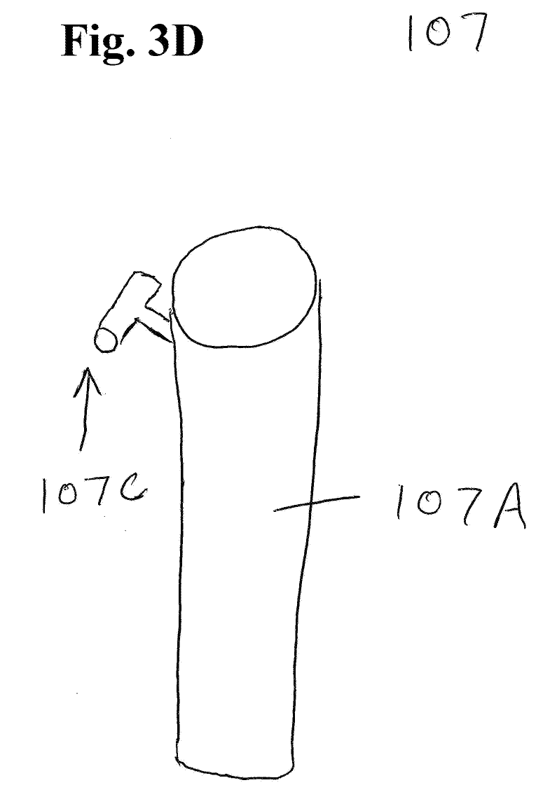

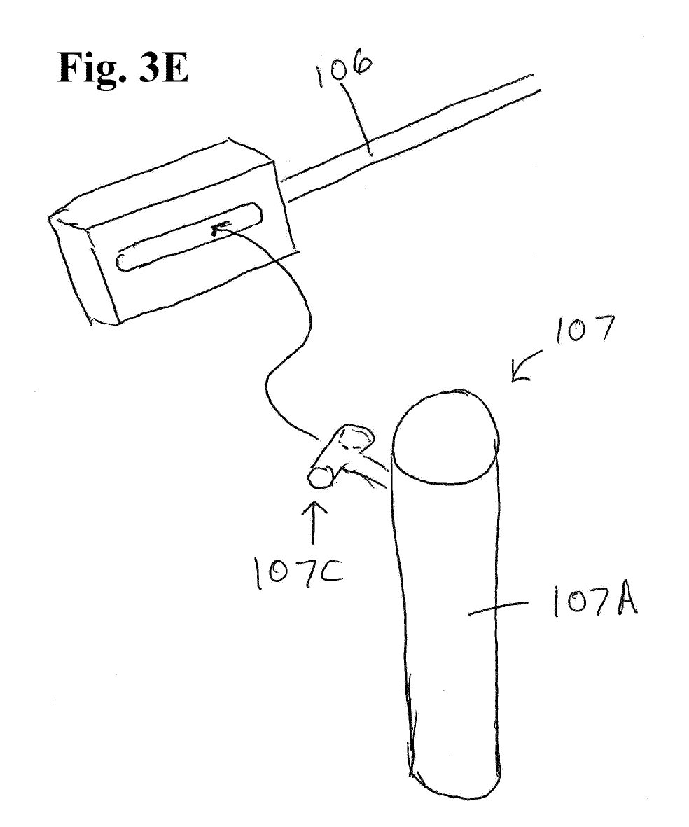

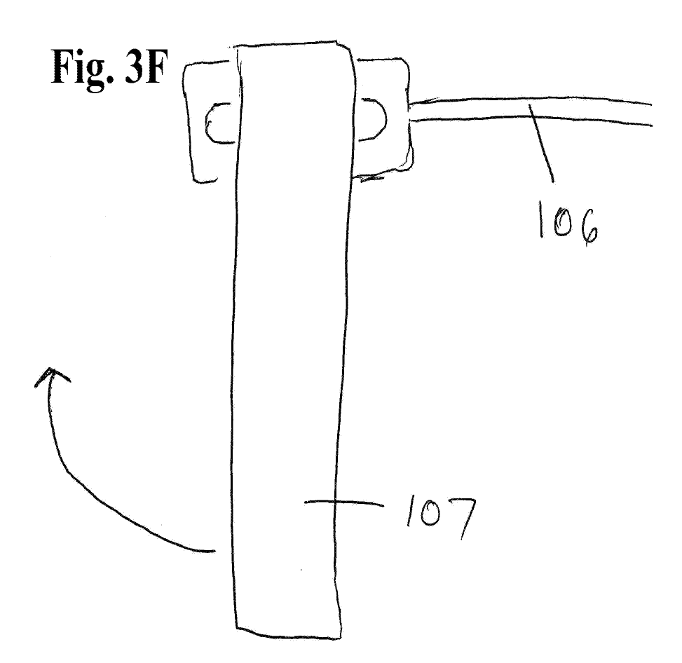

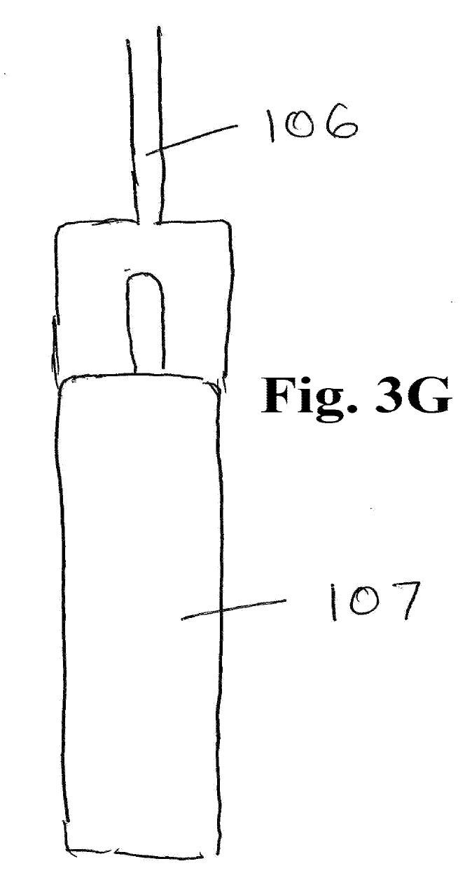

Another version of the multi faceted roadside motor vehicle emergency marker 100 is shown in FIG. 3 through FIG. 3G. The version depicted in these figures make up the same version as the abovementioned described version but a part of the body rod and attachment member 106 is different. With the version depicted in these figures (FIG. 3 through FIG. 3G) a different terminal obstruction member with stem 106A exists. This version of the terminal obstruction member 2 106C is a square piece of rubber with an elongated opening on the front and is partly hollow on the inside. This opening and hollow part exists to receive the illuminator 107 that is to go with this particular version (version shown in FIG. 3 through FIG. 3G).

The illuminator 107 of this version is like a typical glowstick but near one end there is a T shaped handle or attachment member extending out of it. This T shaped attachment member is to align in the opening of the squared shaped terminal obstruction member, pushed in, and then turned about 90 degrees. This aids to secure the illuminator to the body rod and attachment member 106. After the illuminator 107 is turned 90 degrees the illuminator 107 should be substantially vertically aligned with the body rod and attachment member 106. The illuminator 106 could be aligned in other angles with the body rod and attachment member 106 and not limited to being aligned vertically with it.

The terminal obstruction member of this version is not limited to a square shape can be other shapes. The handle and attachment member stemming from the illuminator does not have to be T shaped and can be other shapes.

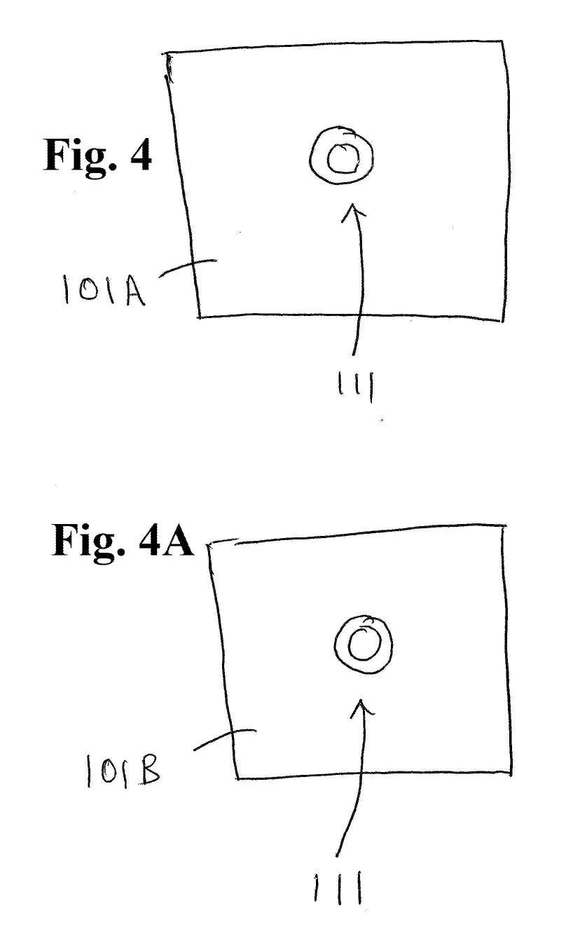

Another version of the multi faceted roadside motor vehicle emergency marker 100 is shown in FIG. 4 through FIG. 4A. This version is the same as the version depicted in FIG. 1 through FIG. 2V but instead of a grommet with teeth 110 being used a circular grommet without teeth (as is used described or shown in the version depicted by FIG. 4 through FIG. 4A). This version allows the grommet and marker body to move more freely up and down the body rod and attachment member 106. The diameter of this grommet would still preferably smaller than the diameter of the two terminal obstruction members. This is so the terminal obstruction member can serves as obstructers and keep the grommet moving about and in between the ends of the body rod.

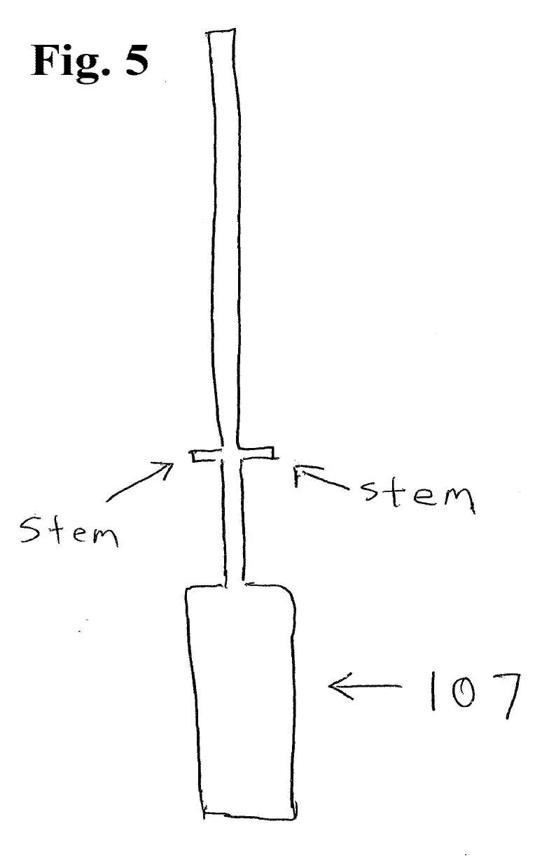

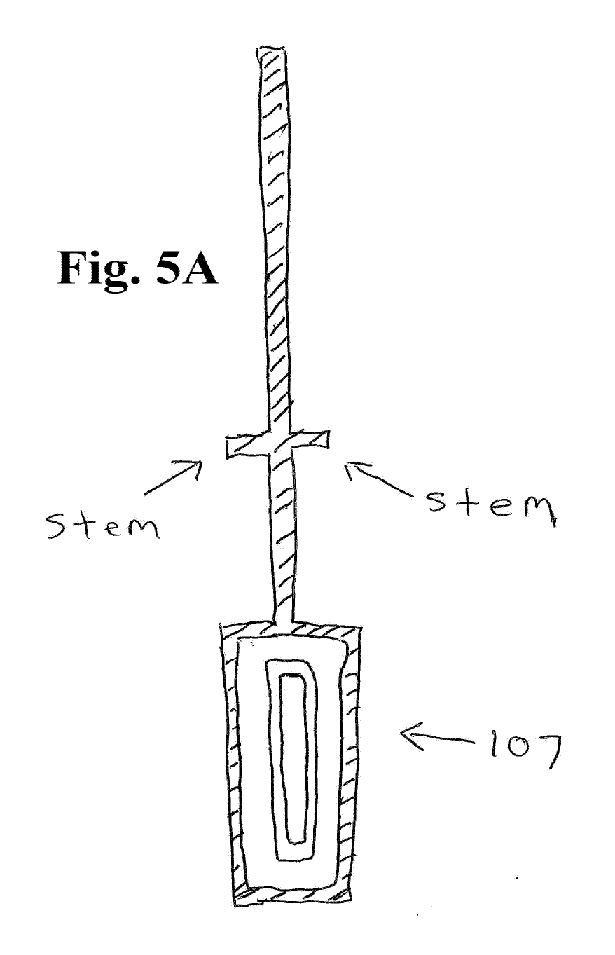

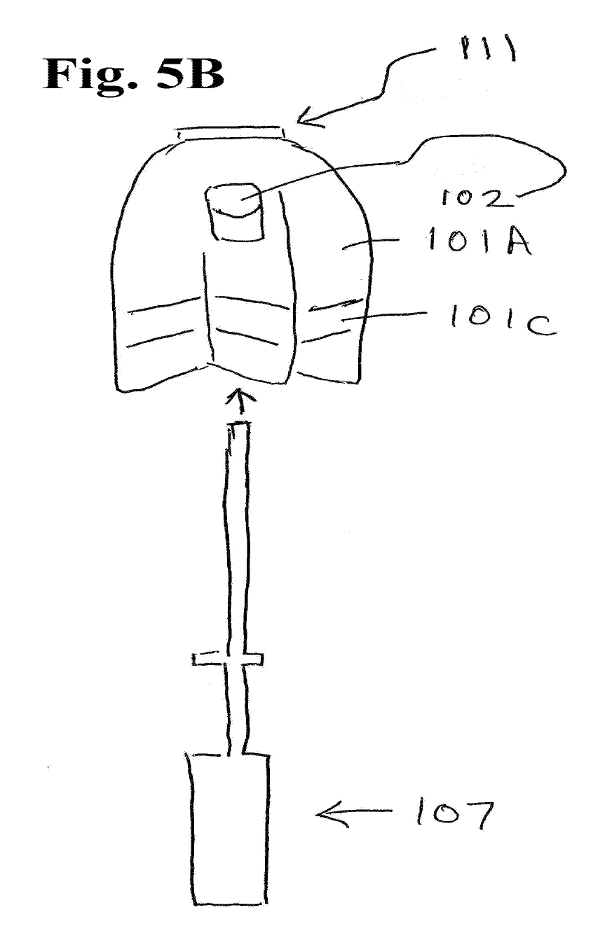

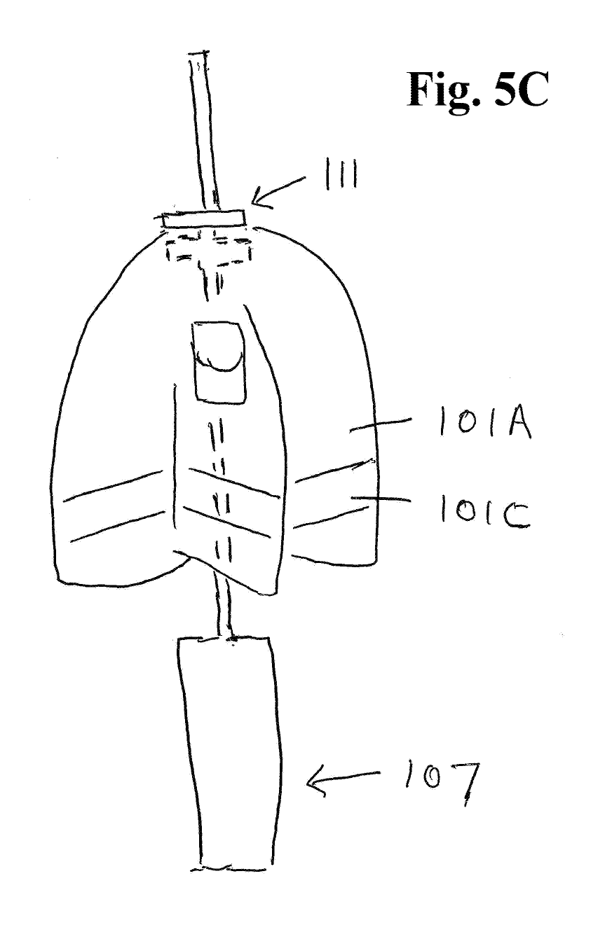

Another version of the multi faceted roadside motor vehicle emergency marker 100 is shown in FIG. 5 through FIG. 5C. This version is the same as the version depicted in FIG. 1 through FIG. 2V but the body rod and illuminator are different. With this version (version being shown by FIG. 5 through FIG. 5C) the illuminator 107 has stem coming from one end of the illuminator body 107A. About the middle of the stem exists two shorter stems. One protruding from the left side going horizontally. Then there is another stem protruding from the right side going horizontally. When the end of the stem directly vertically opposite the side that is connected to the illuminator body 107A is entered through the grommet with teeth 110 then the grommet and marker body can be moved down to the point where it meets the horizontal stems. The two horizontal stems serve as two terminal obstruction members. In this case the two horizontal stems are terminal as they can stop the event of the grommet with teeth and marker body from moving all the way down to meet he illuminator body. These two horizontal stems also serve as obstruction members because they can also obstruct the movement of the grommet with teeth 110. When they obstruct the grommet with teeth 110 and marker body 102 attached to it, it leaves a clearance for the illuminator body 107A to illuminate while being substantially uncovered by the rest of the device.

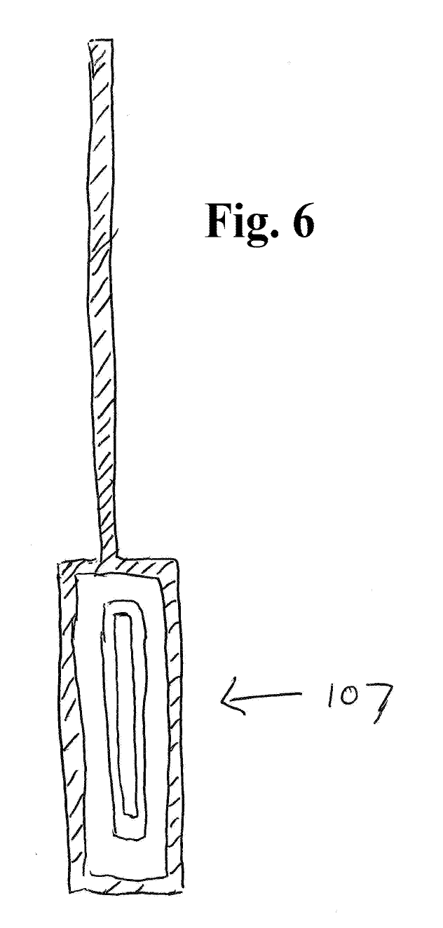

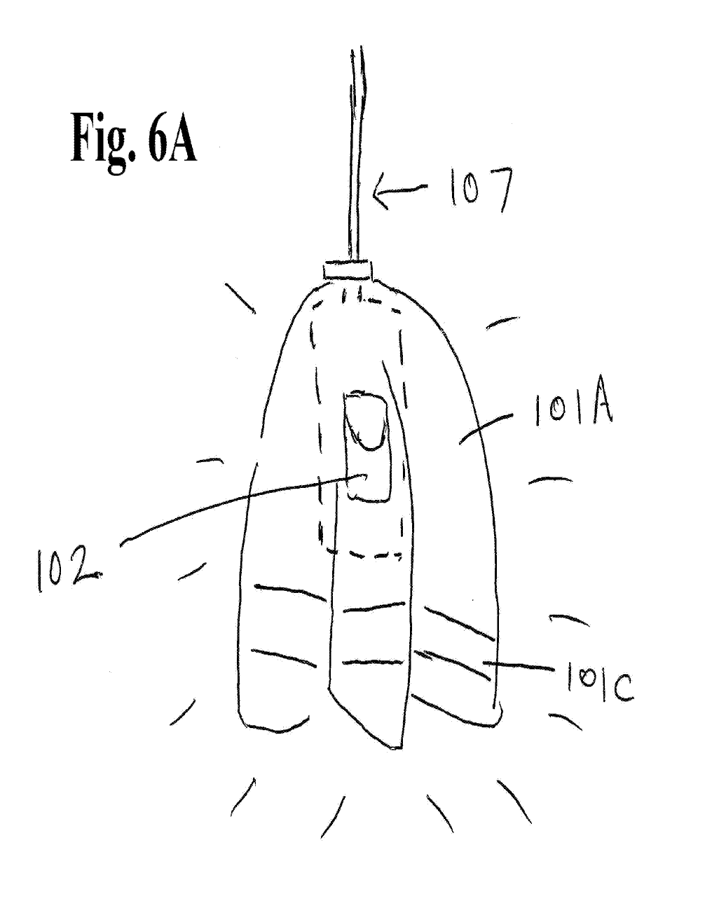

The end of the stem that is directly vertically opposite the side of the stem that is connected to the illuminator body 107A will not be connected to a rubber ball (rubber ball as is shown in the version depicted in FIG. 1 through FIG. 2V). The illuminator body 107A and the stem connected to it are preferably made of plastic but can be made of other materials. This stem is preferably flaccid or flexible enough so that the user can tie a part of the rod around a part of the motor vehicle. This stem end could also be shut in between a motor vehicle area that closes. The version depicted in FIG. 5 through FIG. 5C is not limited to this particular configuration described or shown. Another version of the multi faceted roadside motor vehicle emergency marker 100 is shown in FIG. 6 through FIG. 6A. This version is the same as the version depicted in FIG. 5 through FIG. 5C but there are not two stems protruding horizontally from the sides of the stem connected to the illuminator body 107A.

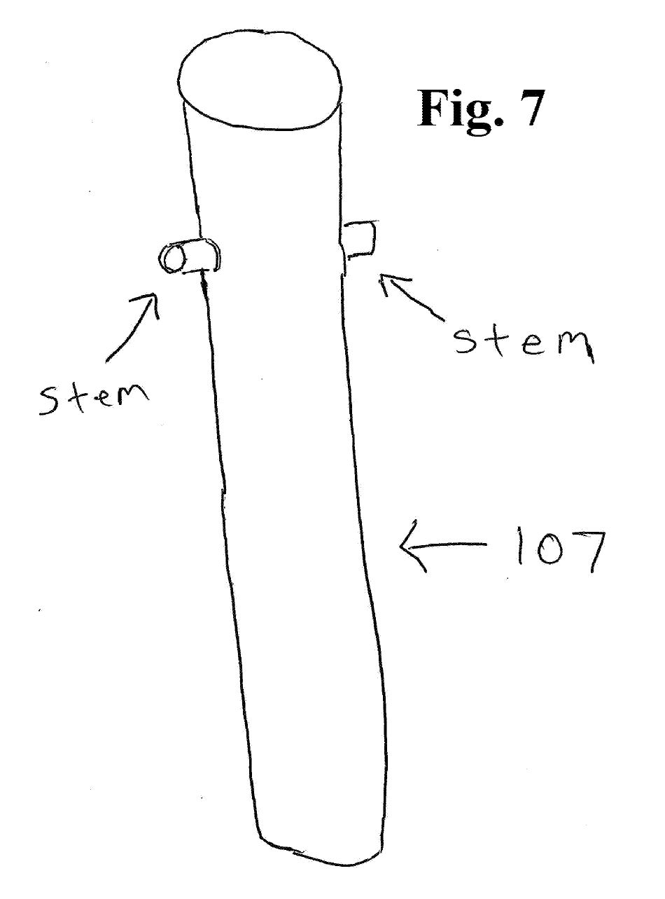

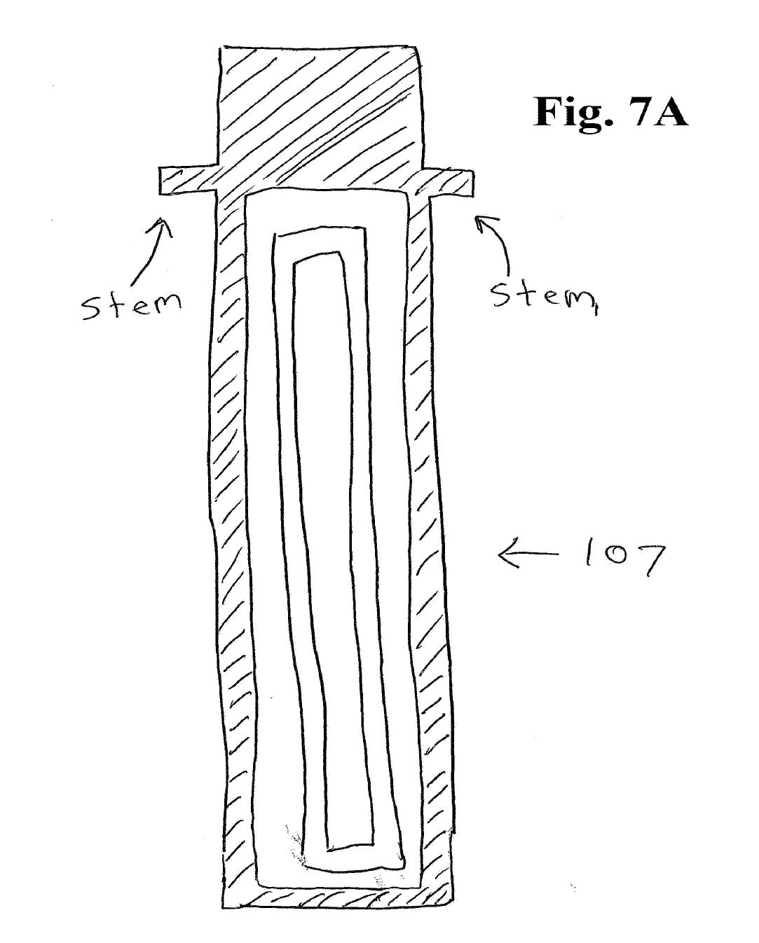

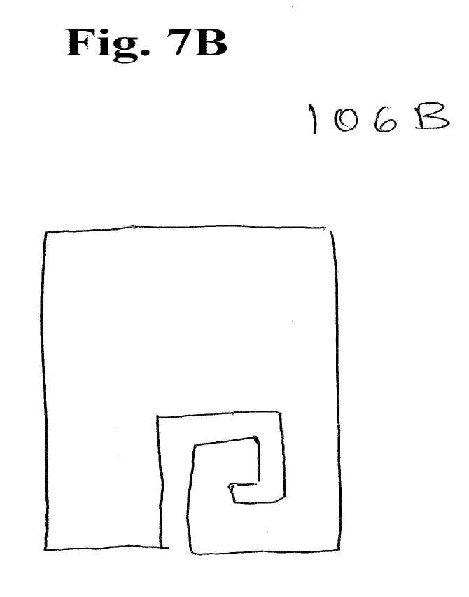

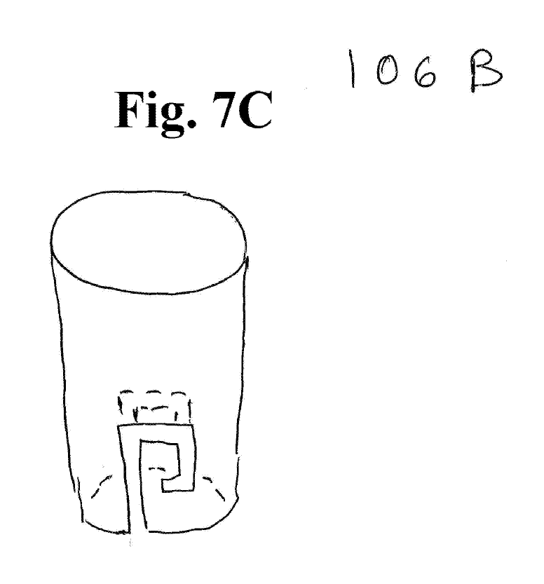

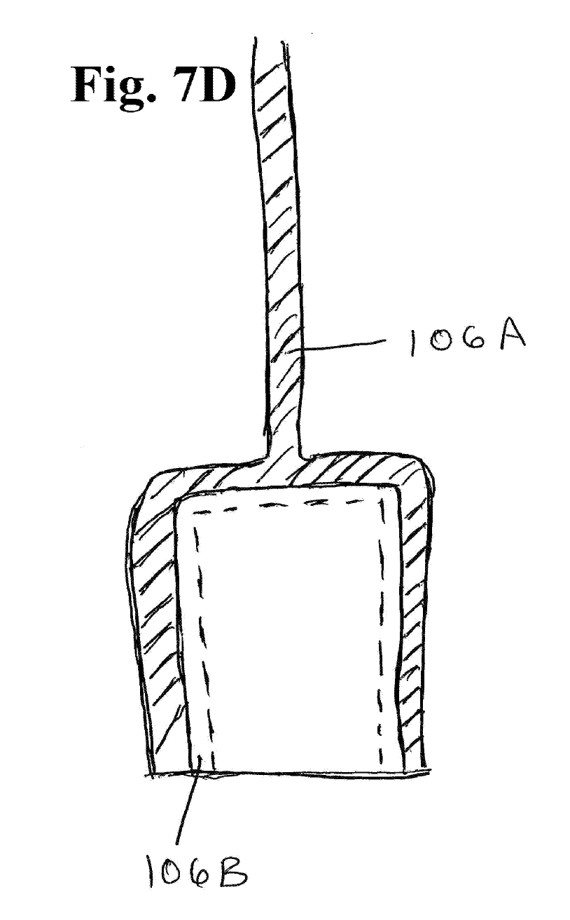

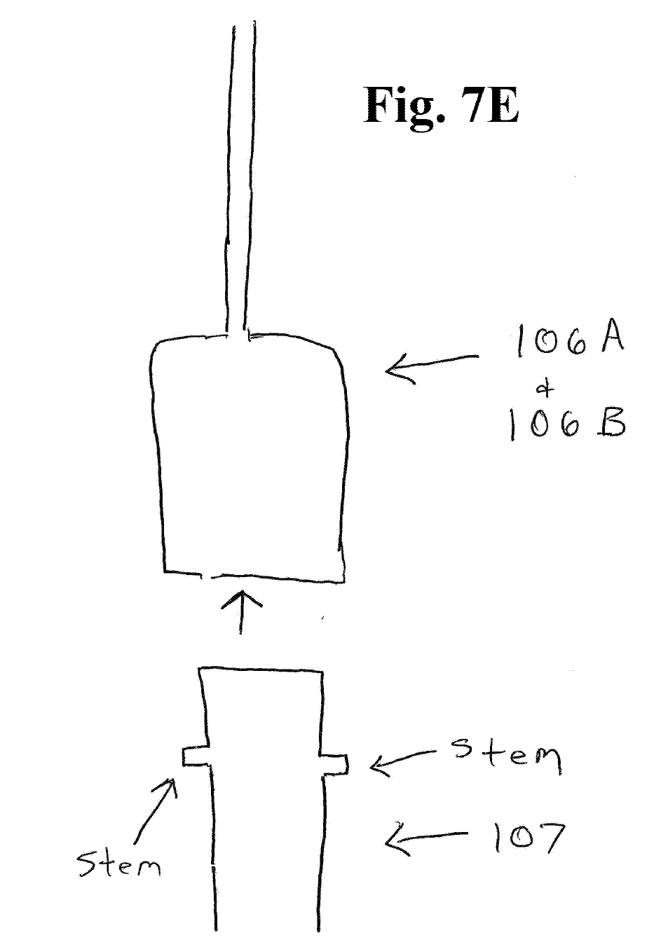

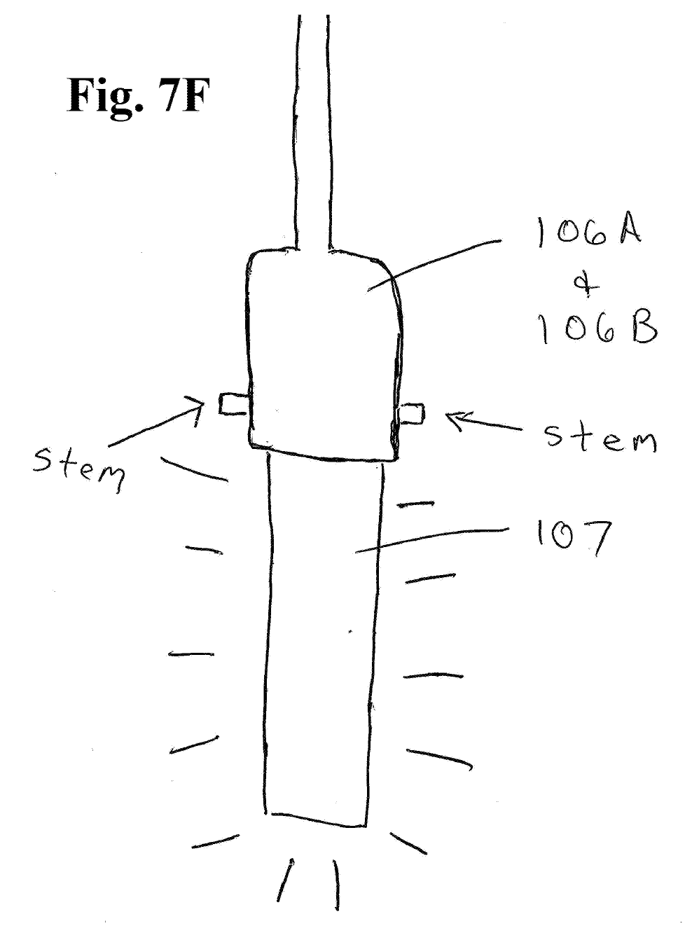

Another version of the multi faceted roadside motor vehicle emergency marker 100 is shown in FIG. 7 through FIG. 7F. This version is the same as the same as the version depicted in FIG. 1 through FIG. 2V but this version (as shown in FIG. 7 through FIG. 7F) uses a bayonet style socket for the illuminator receiving socket 106B. The illuminator of this version has two stems. Each stem extends horizontally from the left and right sides near one end of the illuminator 107. This is so the illuminator can be inserted into the bayonet base style socket and be held or secured within it. The socket or cup like end of the terminal obstruction member with stem 106A will preferably have a J shaped cut out on the sides of it so it can align up with the J shapes on each side of the bayonet base style socket that serves as a the illuminator receiving socket 106B. This is so the stems protruding from the horizontal stems of the illuminator 107 can move freely as the illuminator is connected to the bayonet style base that is the illuminator receiving socket 106B.

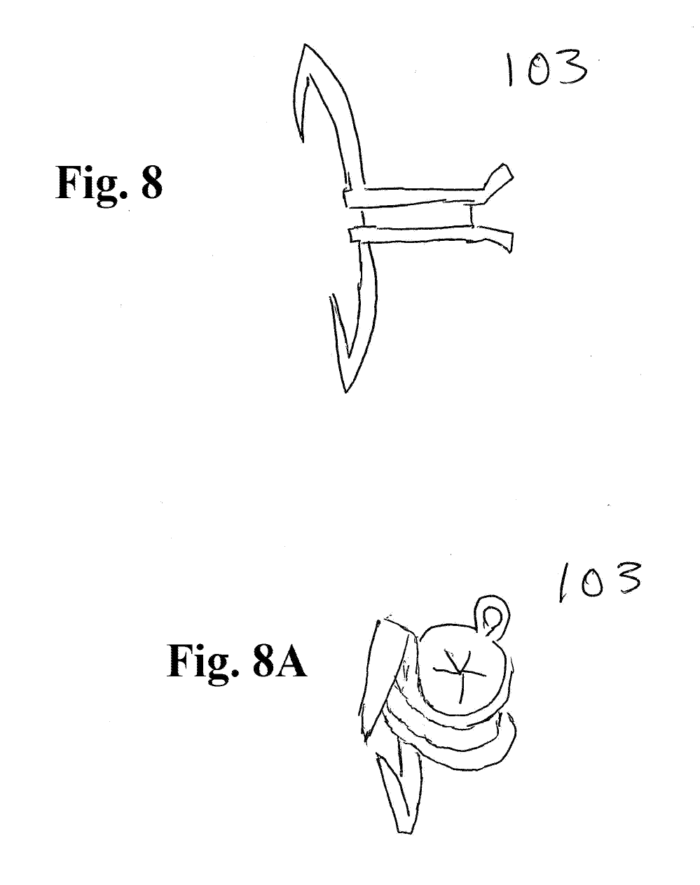

Another version of the multi faceted roadside motor vehicle emergency marker 100 is shown FIG. 8 through FIG. 8A. This version is similar to the version depicted in FIG. 1 through FIG. 2V but the window attachment member 103A and the antenna attachment member 103B are connected to the grommet with teeth 110. Just like the version depicted from FIG. 1 through FIG. 2V there will be a window hook on any side the user wishes to use. Also there will be hole for the antenna on any side the user wishes to use.

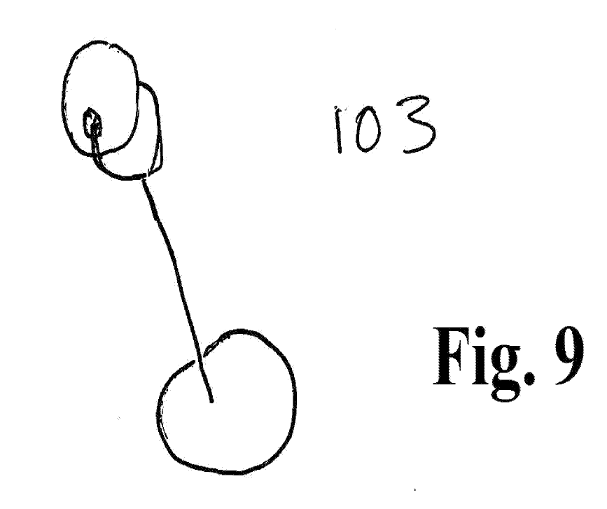

Another version of the multi faceted roadside motor vehicle emergency marker 100 is shown in FIG. 9. This version shows a flaccid type attachment member that can be used on the multi-faceted roadside motor vehicle attachment member. This can be used instead of the window hook feature, or used in addition to it. One end of the flaccid material is connected to a rubber ball with a hole. This rubber ball will serve as a terminal obstruction member. The other end of the flaccid material is connected to a flat round rubber disc base. The base would be attached to the marker body 102. The ball and the flat round disc are not limited to being made of rubber and can be made of other materials and not limited to these sizes or configurations.

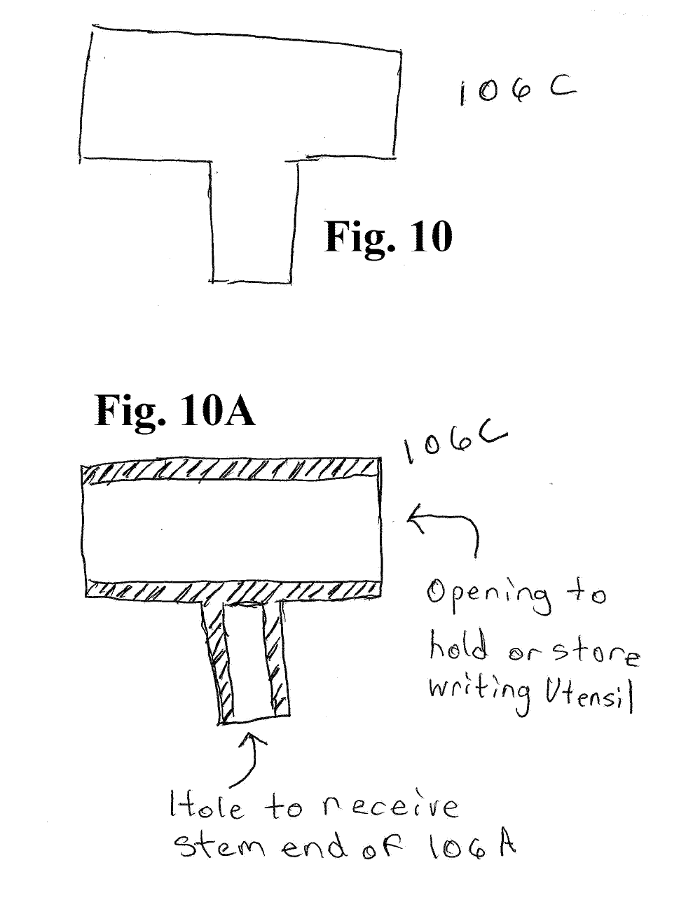

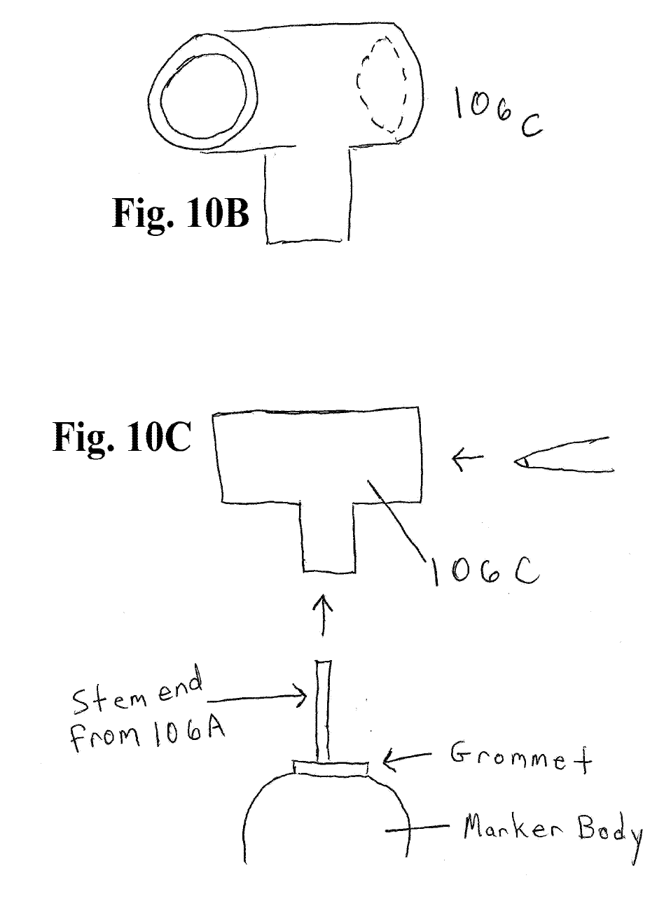

Another version of the multi faceted roadside motor vehicle emergency marker 100 is shown in FIG. 10 through FIG. 10C. This version is the same as the version depicted in FIG. 1 through FIG. 2V but the terminal obstruction member 2 106C is a T shape member that is hollow. The horizontal part of the T has an opening within it so that it can hold or secure a writing utensil. The vertical part of the T is hollow and is designed to receive the end of the stem from the terminal obstruction member with stem 106A after it has gone through the grommet. It is preferred that the diameter of the T shaped terminal obstruction member 2 106C is larger than the inner diameter of the grommet so that the terminal obstruction member 2 106C can restrict the movement of the grommet and the marker body 101 attached to it as well as obstruct the grommet. The diameter of the T shaped terminal obstruction member 2 106C can be other sizes. The terminal obstruction member 2 106C of this version of the invention is not limited to being a T shaped.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A Roadside Emergency Marker comprising:
a body rod, adapted for longitudinal length adjustment, with two terminal obstruction members thereon; and
a marker comprising: a grommet, adapted to selectively affix to said body rod and selectively longitudinally travel along said body rod; and a flaccid, substantially-planar, pliable signal, affixed to said grommet, having a reflective surface and a dull surface.
An attachment member, affixed to said signal, dimensioned to accept a substantially planar, rigid body.
An attachment member, affixed to said body rod, dimensioned to accept a substantially planar, rigid body.
An attachment member, affixed to said body rod, dimensioned to internally accept a cylindrical, rigid body.
An attachment member, affixed to said signal, dimensioned to internally accept a cylindrical, rigid body.
An attachment member, affixed to said signal, dimensioned to internally accept a cylindrical, rigid body and a cylindrical, rigid body.
A translucent message sleeve, contacting said marker body, with a message reservoir adapted to accept a document;
A fastening member, positioned on said marker body for the fastening of a writing utensil;
An illuminator adapted to illuminate a portion of said signal.
